(19) United States
(12) Patent Application Publication
(10) Pub. No.: US 2026/0233060 A1
(43) Pub. Date: Aug. 13, 2026

(54) ELECTRONIC DEVICE FOR PROVIDING VARIOUS EXERCISE EXPERIENCES USING EXERCISE ASSISTANCE DEVICE, WEARABLE DEVICE, AND CONTROL METHOD FOR CONTROLLING EXERCISE ASSISTANCE DEVICE

(71) Applicant: Samsung Electronics Co., Ltd., Suwon-si, Gyeonggi-do (KR)

(72) Inventor: Sungcheol KIM, Suwon-si (KR)

(21) Appl. No.: 19/638,248

(22) Filed: Apr. 3, 2026

Related U.S. Application Data
(63) Continuation of application No. PCT/KR2024/012794, filed on Aug. 27, 2024.

(30) Foreign Application Priority Data
Oct. 6, 2023 (KR) 10-2023-0133447

(51) Int. Cl. A63B 24/00; A63B 21/00

(52) U.S. Cl. CPC A63B 24/0087; A63B 21/4009; A63B 2024/009; A63B 2220/16; A63B 2220/34; A63B 2220/44

(57) ABSTRACT

An electronic device may include a processor and a communication module which communicates with the exercise assistance device. The processor determines target exercise content to be executed on the basis of a first user input including a selection of one piece of candidate exercise content using the exercise assistance device, determines a torque profile of the target exercise content on the basis of a second user input including a selection of an exercise experience attribute associated with the target exercise content, generates a control signal to drive the exercise assistance apparatus on the basis of the determined torque profile, and controls the communication module to transmit the control signal to the exercise assistance device.

### CROSS-REFERENCE TO RELATED APPLICATIONS

This application is a continuation application of International Application No. PCT/KR2024/012794, filed on Aug. 27, 2024, in the Korean Intellectual Property Receiving Office, and claiming priority to KR Application No. 10-2023-0133447 filed Oct. 6, 2023, the disclosures of which are all hereby incorporated by reference herein in their entireties.

### TECHNICAL FIELD

Certain example embodiments may relate to an electronic device for providing various exercise experiences using an exercise assistance device, a wearable device, and/or a control method of controlling the exercise assistance device.

### BACKGROUND

In general, a walking assistance device is a tool or device that helps patients who may not walk independently due to illness or injury to perform walking exercises for rehabilitation and/or a tool or device that may be used for exercise purposes. With the aging of society, the number of people experiencing difficulty walking or discomfort due to leg joint problems has been increasing, which has led to growing interest in walking assistance devices. A walking assistance device may be worn on a user's body and may assist the muscles needed for walking, guiding the user to walk with a normal gait pattern. The walking assistance device may also perform functions that help a user with various leg exercises (e.g., power walking, jogging, stair climbing, lunges, and stretching).

### SUMMARY

According to an example embodiment, an electronic device may include a processor, comprising processing circuitry, and a communication module (comprising communication circuitry) configured to communicate with an exercise assistance device. The processor (which may include one or more processors as discussed herein) may be configured to, based on a first user input including a selection of any one of pieces of candidate exercise content using the exercise assistance device, determine a piece of target exercise content to be executed. The processor may be configured to, based on a second user input including a selection of an exercise experience attribute associated with the piece of target exercise content, determine a torque profile of the piece of target exercise content. The processor may be configured to generate a control signal for driving the exercise assistance device according to the determined torque profile and control the communication module to transmit the control signal to the exercise assistance device. According to the selected exercise experience attribute, based on at least one of a hip joint angle, a hip joint angular velocity, a hip joint angular acceleration, an angular difference between angles of both hip joints, an angular velocity difference between angular velocities of both hip joints, and an angular acceleration difference between angular accelerations of both hip joints of a user wearing the exercise assistance device, the processor may be configured to determine the torque profile.

According to an example embodiment, an exercise assistance device may include a driving module, including a motor, configured to generate torque, a torque transmission frame for transmitting the generated torque to a leg of a user, a thigh fastening member connected, directly or indirectly, to the torque transmission frame and configured to connect the torque transmission frame to the leg of the user, a sensor module configured to obtain sensor data including motion information of the user, and a processor. The processor may be configured to, based on a first user input including a selection of a piece of target exercise content, determine a piece of target exercise content to be executed from pieces of candidate exercise content using the exercise assistance device. The processor may be configured to, based on a second user input including a selection of an exercise experience attribute associated with the piece of target exercise content, determine a torque profile of the piece of target exercise content and based on the sensor data and the determined torque profile, control output torque of the motor. According to the selected exercise experience attribute, based on at least one of a hip joint angle, a hip joint angular velocity, a hip joint angular acceleration of a user wearing the exercise assistance device, an angular difference between angles of both hip joints, an angular velocity difference between angular velocities of both hip joints, and an angular acceleration difference between angular accelerations of both hip joints of the user, the processor may be configured to determine the torque profile.

According to an example embodiment, a control method of controlling an exercise assistance device, performed by an electronic device, may include presenting pieces of candidate exercise content using the exercise assistance device, receiving a first user input including a selection of one of the pieces of candidate exercise content, based on the first user input, determining a piece of target exercise content to be executed, receiving a second user input including a selection of an exercise experience attribute associated with the piece of target exercise content, based on the second user input, determining a torque profile of the piece of target exercise content, generating a control signal for driving the exercise assistance device according to the determined torque profile, and transmitting the control signal to the exercise assistance device. The determining of the torque profile may include, according to the selected exercise experience attribute, based on at least one of a hip joint angle, a hip joint angular velocity, a hip joint angular acceleration of a user wearing the exercise assistance device, an angular difference between angles of both hip joints, an angular velocity difference between angular velocities of both hip joints, and an angular acceleration difference between angular accelerations of both hip joints of the user, determining the torque profile.

### BRIEF DESCRIPTION OF DRAWINGS

These and/or other aspects, features and advantages will become apparent and more readily understood from the following description of embodiments, taken in conjunction with the accompanying drawings.

FIG. 1 is a diagram illustrating an overview of an exercise assistance device worn on a body of a user, according to an example embodiment.

FIG. 2 is a diagram illustrating an exercise assistance system according to an example embodiment.

FIG. 3 is a rear schematic diagram of an exercise assistance device according to an example embodiment.

FIG. 4 is a left side view of the exercise assistance device according to an example embodiment.

FIGS. 5A and 5B are diagrams illustrating a configuration of a control system of an exercise assistance device according to an example embodiment.

FIG. 6 is a diagram illustrating an interaction between an exercise assistance device and an electronic device, according to an example embodiment.

FIG. 7 is a diagram illustrating a configuration of an electronic device according to an example embodiment.

FIG. 8 is a flowchart illustrating operations of a control method of controlling an exercise assistance device performed by an electronic device, according to an example embodiment.

FIG. 9 is a flowchart illustrating operations of a control method performed by an exercise assistance device, according to an example embodiment.

FIGS. 10A and 10B are diagrams illustrating screens of user interfaces (UIs) that provide a list of pieces of candidate exercise content and a list of exercise experience attributes, according to an example embodiment.

FIGS. 11A, 11B, and 11C are diagrams illustrating signal waveforms related to a hip joint angle, a hip joint angular velocity, and a hip joint angular acceleration of a user, according to an example embodiment.

FIGS. 12A, 12B, and 12C are diagrams illustrating signal waveforms related to a hip joint angular difference, a hip joint angular velocity difference, and a hip joint angular acceleration difference of both hip joints of a user, according to an example embodiment.

FIGS. 13A, 13B, and 13C are diagrams illustrating examples of providing an exercise experience to a user through an exercise assistance device, according to an example embodiment.

### DETAILED DESCRIPTION

The following structural or functional descriptions of embodiments are provided as examples only, and various alterations and modifications may be made to the embodiments. Accordingly, the embodiments are not construed as limited to the disclosure and should be understood to include all changes, equivalents, and replacements within the idea and the technical scope of the disclosure.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms used herein including technical or scientific terms have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments are described in detail with reference to the accompanying drawings. When describing the embodiments with reference to the accompanying drawings, like reference numerals refer to like components and a repeated description related thereto will be omitted.

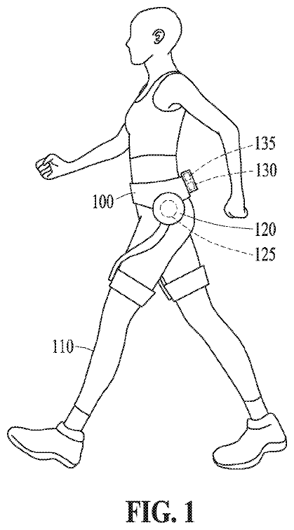

FIG. 1 is a diagram illustrating an overview of an exercise assistance device worn on a body of a user, according to an embodiment.

Referring to FIG. 1, an exercise assistance device 100 may be a device worn on a body of a user 110 to assist the user 110 in walking and/or exercising. In an embodiment, the exercise assistance device 100 may be used to assist the user 110 in working or to measure the physical ability (e.g., walking ability, exercise ability, and exercise posture) of the user 110. The term “exercise assistance device” may be replaced with the term “wearable device,” “wearable robot,” “exercise device,” or “walking assistance device.” The user 110 may be a person who wears the exercise assistance device 100 and walks or exercises.

The exercise assistance device 100 may be worn on the body (e.g., a lower body (the legs, ankles, knees, etc.), an upper body (the torso, arms, wrists, etc.), or the waist) of the user 110 to apply an external force such as an assistance force and/or a resistance force to a body motion of the user 110. The assistance force may be a force assisting the body motion of the user 110, which is applied in the same direction as a direction of the body motion of the user 110. The resistance force may be a force impeding the body motion of the user 110, which is applied in an opposite direction to the direction of the body motion of the user 110. The term “resistance force” may also be referred to as an “exercise load.”

In an embodiment, the exercise assistance device 100 may operate in a walking assistance mode for assisting the walking of the user 110. In the walking assistance mode, the exercise assistance device 100 may assist the walking of the user 110 by applying an assistance force generated through a driving module 120 of the exercise assistance device 100 to the body of the user 110. The exercise assistance device 100 may expand the walking ability of the user 110 by allowing the user 110 to walk independently or walk for a long time by providing a force needed for the walking of the user 110. The exercise assistance device 100 may also help improve the walking of a pedestrian whose walking habit or posture are abnormal.

In an embodiment, the exercise assistance device 100 may operate in an exercise assistance mode for enhancing the effect of exercise of the user 110 or providing various exercise experiences to the user 110. The exercise assistance mode may include a resistance mode and/or an assistance mode. The resistance mode may be a mode for hindering the body motion of the user 110 or providing resistance to the body motion of the user 110 by applying a resistance force generated by the driving module 120 to the body of the user 110. When the exercise assistance device 100 is a hip-type wearable device that is worn on the waist (or pelvis) and legs (e.g., thighs) of the user 110, the exercise assistance device 100 may provide an exercise load to a leg motion of the user 110 while being worn on the legs in the resistance mode, thereby enhancing the effect of exercise on the legs of the user 110. The assistance mode may be a mode for applying an assistance force for assisting the body motion of the user 110 to the body of the user 110. In the assistance mode, an assistance force in the same direction as a body motion may be provided to the user 110. For example, when a person with a disability or an elderly person wears the exercise assistance device 100 to exercise, the exercise assistance device 100 may provide an assistance force to assist a body motion. In the assistance mode, the exercise assistance device 100 may provide a force in the same direction as a motion direction of a leg of the user 110, and the user 110 may exercise with a little force. In a piece of exercise content performed using the exercise assistance device 100, the resistance mode and the assistance mode may be combined and operated. For example, the exercise assistance device 100 may provide an assistance force and a resistance force in combination for each exercise session or time interval in such a manner of providing an assistance force in one exercise session and providing a resistance force in another exercise session. In the exercise assistance mode, various pieces of exercise content may be operated depending on the exercise purpose and/or the physical ability of the user 110. A piece of exercise content may be an exercise program that the user 110 performs using the exercise assistance device 100 and may include, for example, cardio exercises, strength training, posture balancing, or any combination thereof. The type of the piece of exercise content is not limited thereto and may be various. The resistance mode and the assistance mode may be alternately activated appropriately depending on a piece of exercise content performed by the exercise assistance device 100, and a target exercise speed (e.g., kilometers per hour (km/h)) that is suitable to an appropriate physical condition (e.g., a heart rate) of the user 110 may be provided as guidance to the user during the exercise of the user 110.

In an embodiment, the exercise assistance device 100 may operate in a physical ability measurement mode to measure the physical ability of the user 110. The exercise assistance device 100 may measure motion information of the user 110 using a sensor (e.g., an angle sensor 125 and an inertial measurement unit (IMU) 135) provided in the exercise assistance device 100 during the walking and/or exercise of the user 110 and may assess the physical ability of the user 110 based on the measured motion information. For example, a walking index (e.g., the number of steps, the total walking distance, or a stride length) or an exercise ability indicator (e.g., muscular strength, endurance, or balance) of the user 110 may be estimated through the motion information of the user 110 measured by the exercise assistance device 100.

In some embodiments, the description is provided based on an example of the hip-type exercise assistance device 100 as shown in FIG. 1. However, embodiments are not limited thereto. As described above, the exercise assistance device 100 may be worn on other body parts (e.g., upper arms, lower arms, hands, calves, or feet) other than the waist and legs (particularly, thighs). The shape and configuration of the exercise assistance device 100 may vary depending on the body part on which the wearable device 100 is worn.

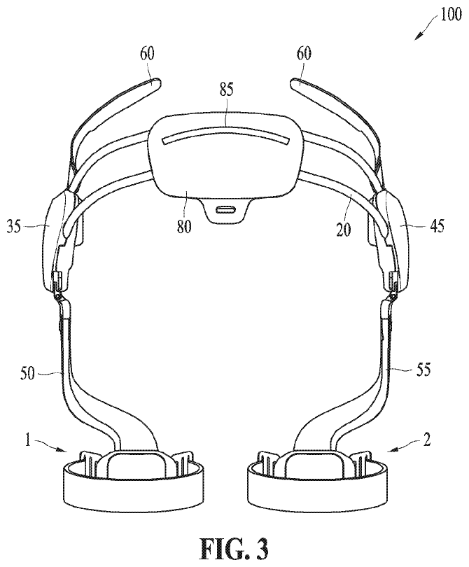

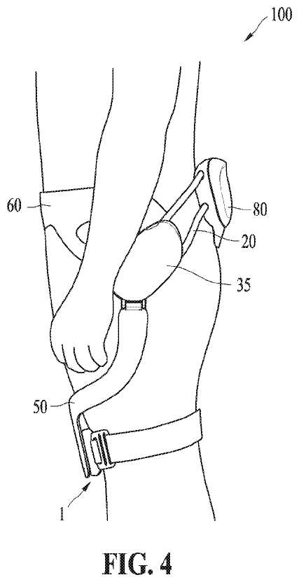

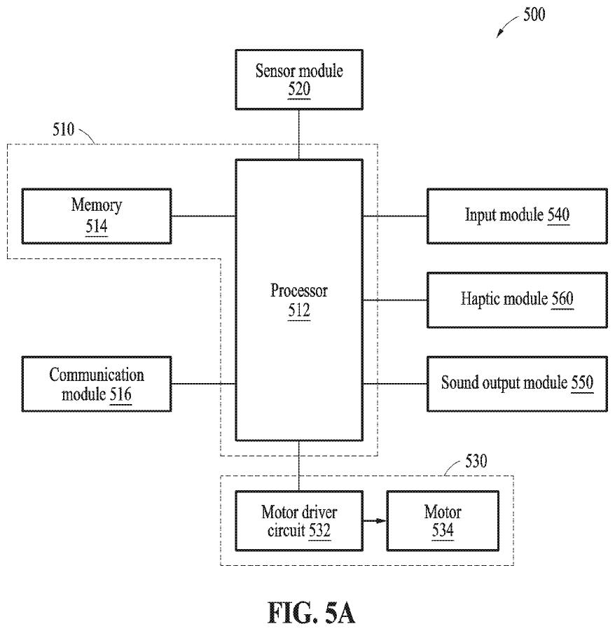

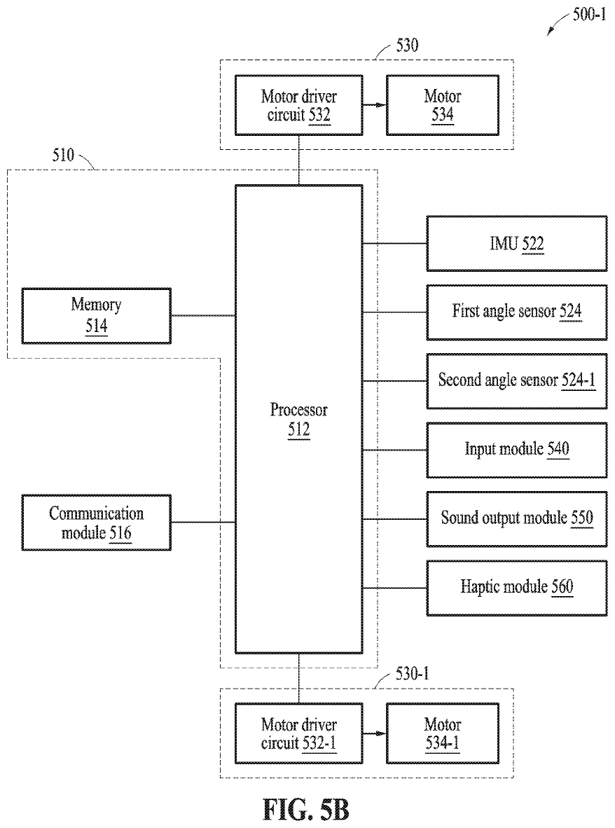

The exercise assistance device 100 may include a support frame (e.g., a waist support frame 20 of FIGS. 3 and 4) for supporting the body of the user 110 when the exercise assistance device 100 is worn on the body of the user 110, a driving module 120 (e.g., a first driving module 35 and a second driving module 45 of FIG. 3) configured to generate torque applied to the legs of the user 110, a torque transmission frame (e.g., a first torque transmission frame 55 and a second torque transmission frame 50 of FIG. 3) configured to transmit torque generated by the driving module 120 to the legs of the user 110, a sensor module (e.g., a sensor module 520 of FIG. 5A) including a sensor for obtaining sensor data including motion information about a body motion (e.g., a leg motion or an upper body motion) of the user 110, and a control module 130 (e.g., a control module 510 of FIGS. 5A and 5B) configured to control an operation of the exercise assistance device 100.

In an embodiment, the sensor module may include the angle sensor 125 and the IMU 135. The angle sensor 125 may measure a rotation angle of the torque transmission frame of the exercise assistance device 100 corresponding to a hip joint angle of the user 110. The angle sensor 125 may include, for example, an encoder and/or a Hall sensor.

In an embodiment, the angle sensor 125 may be disposed adjacent to a position where a motor included in the driving module 120 is connected, directly or indirectly, to the torque transmission frame. The IMU 135 may include an acceleration sensor and/or an angular velocity sensor and may measure a change in acceleration and/or angular velocity according to a motion of the user 110. The IMU 135 may measure, for example, a motion value of a waist support frame (e.g., the waist support frame 20 of FIG. 3) or a base body (e.g., a base body 80 of FIG. 3) of the exercise assistance device 100. The motion value of the waist support frame or the base body measured by the IMU 135 may correspond to a waist motion value or an upper body motion value of the user 110.

In an embodiment, the control module 130 and the IMU 135 may be arranged within the base body (e.g., the base body 80 of FIG. 3) of the exercise assistance device 100. The base body may be on the waist of the user 110 when the user 110 wears the exercise assistance device 100. The base body may be formed on or attached to the outside of the waist support frame of the exercise assistance device 100.

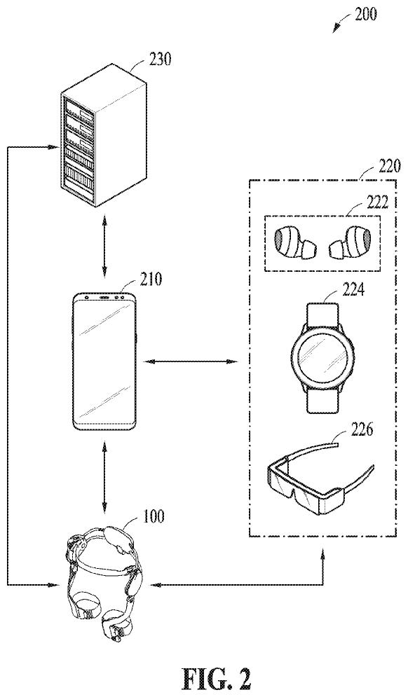

FIG. 2 is a diagram illustrating an exercise assistance system according to an embodiment.

Referring to FIG. 2, an exercise assistance system 200 may include the exercise assistance device 100, an electronic device (or a user terminal) 210, another wearable device 220, and a server 230. In the exercise assistance system 200, at least one of the devices (e.g., the electronic device 210, the other wearable device 220, and the server 230) other than the exercise assistance device 100 may be omitted or at least one device (e.g., a dedicated controller for the exercise assistance device 100) may be added thereto.

In an embodiment, the exercise assistance device 100 may be worn on a body of a user to assist a motion of the user in a walking assistance mode. For example, the exercise assistance device 100 may be worn on legs of the user to help the user in walking by generating an assistance force for assisting a leg motion of the user.

In an embodiment, the exercise assistance device 100 may generate a resistance force for hindering a body motion of the user and/or an assistance force for assisting a body motion of the user and apply the generated resistance force and/or assistance force to the body of the user to enhance the effect of exercise of the user in the exercise assistance mode. In the exercise assistance mode, the user may select a piece of exercise content (e.g., cardio exercise such as power walking and outdoor walking, strength training such as squats, split lunges, dumbbell squats, and lunge and knee ups, a stretching exercise, a posture balancing exercise, or any combination thereof) that the user desires to conduct using the exercise assistance device 100 through the electronic device 210 and/or an exercise intensity applied to the piece of exercise content. The exercise assistance device 100 may control a driving module of the exercise assistance device 100 according to the piece of exercise content selected by the user. The exercise assistance device 100 may adjust the strength of the resistance force and/or the assistance force applied to the user based on the exercise intensity selected by the user. For example, the exercise assistance device 100 may control the driving module to generate a resistance force corresponding to the exercise intensity selected by the user. As the exercise intensity increases, the strength of the resistance force applied to the user may increase.

The exercise assistance device 100 may transmit sensor data measured by a sensor (e.g., an angle sensor and an IMU) to the electronic device 210 and may receive, from the electronic device 210, a control signal associated with an operation of the exercise assistance device 100. The exercise assistance device 100 may provide (or output) feedback (e.g., visual, auditory, or haptic feedback) corresponding to a state of the exercise assistance device 100 according to the control signal received from the electronic device 210. For example, the exercise assistance device 100 may provide visual feedback through a lighting unit (e.g., a lighting unit 85 of FIG. 3) and auditory feedback through a sound output module (e.g., a sound output module 550 of FIGS. 5A and 5B).

The electronic device 210 may communicate with the exercise assistance device 100 through wireless communication, may remotely control the exercise assistance device 100, or may provide state information about a state (e.g., a booting state, a charging state, a sensing state, and an error state) of the exercise assistance device 100 to the user. The electronic device 210 may recommend a piece of exercise content using the exercise assistance device 100 to the user and may analyze an exercise performed by the user.

The electronic device 210 may receive sensor data obtained by the sensor of the exercise assistance device 100 from the exercise assistance device 100, and estimate a current exercise state, an exercise result, an exercise posture, and/or a physical ability of the user based on the received sensor data. The electronic device 210 may provide the user with the estimated current exercise state, exercise result, exercise posture, and/or physical ability of the user through a graphical user interface (GUI).

In an embodiment, the user may execute a program (e.g., an application) in the electronic device 210 to control the exercise assistance device 100 and may adjust an operation or a setting value (e.g., a torque magnitude output by a motor of a driving module, a volume of audio output by a sound output module, and brightness of a lighting unit) of the exercise assistance device 100 through the program. The program executed by the electronic device 210 may provide the GUI for an interaction with the user. The electronic device 210 may be a device in various forms. For example, the electronic device 210 may include a portable communication device (e.g., a smartphone), a computer device, an access point, a portable multimedia device, or a home appliance (e.g., a television, an audio device, or a projector device), but embodiments are not limited thereto.

According to an embodiment, the electronic device 210 may be connected to the server 230 using short-range wireless communication or cellular communication. The server 230 may receive user profile information of the user who uses the exercise assistance device 100 from the electronic device 210, and store and manage the received user profile information. The user profile information may include, for example, information about at least one of a name, age, gender, height, weight, medical history, or body mass index (BMI). The server 230 may receive exercise history information about an exercise performed by the user from the electronic device 210, and store and manage the received exercise history information. The server 230 may provide the electronic device 210 with various exercise programs or physical ability measurement programs to be provided to the user. In an embodiment, the server 230 may be connected to the exercise assistance device 100. The server 230 may receive, from the exercise assistance device 100, the sensor data measured by the exercise assistance device 100 and transmit, to the exercise assistance device 100, a control signal for controlling an operation of the exercise assistance device 100 and/or data related to a piece of exercise content. In an embodiment, the server 230 may be a cloud server.

According to an embodiment, the exercise assistance device 100 and/or the electronic device 210 may be connected, directly or indirectly, to the other wearable device 220. Exercise result information, physical ability information, and/or exercise posture assessment information of the user that are determined by the electronic device 210 may be transmitted to the other wearable device 220 and provided to the user through the other wearable device 220. State information of the exercise assistance device 100 may also be transmitted to the other wearable device 220 and provided to the user through the other wearable device 220. In an embodiment, the exercise assistance device 100, the electronic device 210, and the other wearable device 220 may be connected to each other through wireless communication (e.g., Bluetooth™ or wireless fidelity (Wi-Fi) communication). The other wearable device 220 may be, for example, wireless earphones 222, a watch-type wearable device (e.g., a smartwatch) 224, or a vision wearable device (a glasses-type or goggle-type wearable device) 226, but embodiments are not limited thereto. The vision wearable device 226 may be, for example, augmented reality (AR) glasses, virtual reality (VR) glasses, or a head mounted display (HMD) device.

In an embodiment, the wireless earphones 222 may be wirelessly connected to the electronic device 210 and/or the exercise assistance device 100 and may output a guide voice, music, and/or sound effect related to a piece of exercise content. The wireless earphones 222 may provide information related to the piece of exercise content (e.g., introduction of the piece of exercise content or a remaining exercise time) to the user or inquire about a selection of the user through the guide voice. The wireless earphones 222 may include a microphone, and the microphone may receive a voice input from the user. The voice input received through the microphone may be transmitted to the electronic device 210, and voice recognition for the voice input may be performed by the electronic device 210.

In an embodiment, the watch-type wearable device 224 may include a biometric sensor (e.g., a heart rate sensor or an electromyography sensor) configured to measure a biosignal, including heart rate information of the user, and transmit the biosignal measured by the biometric sensor to the electronic device 210 and/or the exercise assistance device 100. For example, the electronic device 210 may estimate the heart rate information (e.g., the current heart rate, the maximum heart rate, and the average heart rate) and/or electromyography information of the user based on the biosignal received from the watch-type wearable device 224, and provide the user with the estimated heart rate information and/or electromyography information. The heart rate information and/or the electromyography information may be used to determine the haptic intensity of haptic feedback provided through the exercise assistance device 100.

In an embodiment, the watch-type wearable device 224 may include an IMU configured to measure motion information of the user and/or a position sensor configured to measure position information of the user, and transmit the motion information and/or position information of the user to the electronic device 210 and/or the exercise assistance device 100. The watch-type wearable device 224 may include a communication module (e.g., a short-range communication module) for communicating with another device (e.g., the electronic device 210 and the exercise assistance device 100). In an embodiment, the watch-type wearable device 224 may further include a display and provide an interface related to a piece of exercise content through the display. The interface related to the piece of exercise content may be implemented through a separate application installed on the smartwatch 224. The user may also control the exercise assistance device 100 through the watch-type wearable device 224.

In an embodiment, the vision wearable device 226 may provide a piece of visual content to the user through the display. For example, the vision wearable device 226 may output information about a current exercise speed, a target exercise speed, a currently achieved exercise amount, an exercise time, and biometric information, through a display in the exercise mode. Additionally, the vision wearable device 226 may provide the user with a piece of AR content or a piece of VR content related to a piece of exercise content. The vision wearable device 226 may include a display for outputting a piece of visual content, a processor for processing data, memory, and a sensor (e.g., an IMU, a proximity sensor, and a camera). The vision wearable device 226 may further include a sound output module for outputting a piece of auditory content (e.g., a music/sound effect and guide voice of a piece of exercise content). The vision wearable device 226 may be connected to the exercise assistance device 100 or may be connected to the exercise assistance device 100 via the electronic device 210.

The exercise assistance system 200 may provide the user with various exercise experiences using the exercise assistance device 100. According to an embodiment, the user may perform physical exercise through the exercise assistance device 100 while wearing the exercise assistance device 100 and the vision wearable device 226 and may experience exercise in a virtual environment (e.g., walking in water with waves and walking/running on a sandy beach with depressed terrain) through a piece of visual content (e.g., a piece of AR content and a piece of VR content) provided through the vision wearable device 226. According to an embodiment, the user may perform exercise (e.g., walking, fitness exercise, walking in place) using the exercise assistance device 100 in a real environment without using the vision wearable device 226. An environment for providing an exercise experience may be automatically set depending on a device (e.g., the electronic device 210, the watch-type wearable device 224, and the vision wearable device 226) directly or indirectly connected to the exercise assistance device 100. For example, when the exercise assistance device 100 is connected to the electronic device 210 or the watch-type wearable device 224, a piece of candidate exercise content in a real environment may be presented or recommended to the user. When the exercise assistance device 100 is connected to the vision wearable device 226 or connected to the vision wearable device 226 via the electronic device 210, a piece of candidate exercise content in a virtual environment as well as the piece of candidate exercise content in the real environment may be presented or recommended to the user.

The user may select a piece of target exercise content the user wants to perform from among pieces of candidate exercise content (e.g., walking in place, walking in water with waves, walking/running on a sandy beach with depressed terrain) using the exercise assistance device 100 and may select an exercise experience attribute for the piece of target exercise content. The exercise experience attribute may be an attribute that causes a change in an exercise experience provided to the user through the piece of target exercise content. For each piece of exercise content, possible candidate exercise experience attributes may be defined, and the user may select at least one of the candidate exercise experience attributes. For example, for a piece of exercise content that provides an exercise experience of walking in water with waves, an exercise experience attribute that makes one feel small waves, an exercise experience attribute that makes one feel medium waves, and an exercise experience attribute that makes one feel large waves may be defined through output torque of the exercise assistance device 100. Among these exercise experience attributes, the user may select an exercise experience attribute the user wants. Depending on the selected exercise experience attribute, a torque profile used for the torque output of the exercise assistance device 100 may vary. The torque profile is intended to control a torque output of an actuator (or a motor) of the exercise assistance device 100 and may indicate how the torque output of the motor needs to change over time (or according to an exercise phase). In an embodiment, according to the selected exercise experience attribute, based on at least one of a hip joint angle, a hip joint angular velocity, a hip joint angular acceleration of a user wearing the exercise assistance device 100, an angular difference between the angles of both hip joints, an angular velocity difference between the angular velocities of both hip joints, and an angular acceleration difference between the angular accelerations of both hip joints of the user, the torque profile may be determined. Different torque profiles may be used according to the selection of a piece of exercise content and/or an exercise experience attribute, thereby enabling the provision of diverse exercise experiences to the user. For example, different exercise experiences may be provided to the user not through a change in the intensity of the torque output of the exercise assistance device 100, but through a change in the torque profile according to the selection of an exercise experience attribute of the user.

FIG. 3 is a rear schematic diagram of an exercise assistance device according to an embodiment. FIG. 4 is a left side view of the exercise assistance device according to an embodiment.

Referring to FIGS. 3 and 4, the exercise assistance device 100 according to an embodiment may include the base body 80, the waist support frame 20, the driving modules 35 and 45, the torque transmission frames 50 and 55, thigh fastening portions 1 and 2, and a waist fastening portion 60. The base body 80 may include a lighting unit 85. In an embodiment, at least one (e.g., the lighting unit 85) of the components described above may be omitted from the wearable device 100 or one or more other components may be added to the exercise assistance device 100.

The base body 80 may be on the waist of a user when the user wears the exercise assistance device 100. The base body 80 worn on the waist of the user may cushion and support the waist of the user. The base body 80 may be hung on a hip region (an area of the hips) of the user such that the exercise assistance device 100 may not be deviated downward due to gravity while the user is wearing the exercise assistance device 100.

The base body 80 may distribute some of the weight of the exercise assistance device 100 to the waist of the user while wearing the exercise assistance device 100. The base body 80 may be connected, directly or indirectly, to the waist support frame 20. Waist support frame connecting elements (not shown) to be connected, directly or indirectly, to the waist support frame 20 may be provided at both ends of the base body 80.

In an embodiment, the lighting unit 85 may be provided on the outer surface of the base body 80. The lighting unit 85 may include a light source (e.g., light emitting diode (LED)). The lighting unit 85 may emit light in response to a control of a processor (not shown) (e.g., a processor 512 of FIGS. 5A and 5B) of the exercise assistance device 100. In some embodiments, the lighting unit 85 may be controlled to provide (or output) visual feedback corresponding to the state of the exercise assistance device 100 through the lighting unit 85.

The waist support frame 20 may support a body part (e.g., the waist) of the user when the exercise assistance device 100 is worn on the body of the user. The waist support frame 20 may extend from both ends of the base body 80. The lumbar region of the user may be accommodated inside the waist support frame 20. The waist support frame 20 may include at least one rigid body beam. Each beam may be in a curved shape having a preset curvature to enclose the lumbar region of the user. The waist fastening portion 60 may be connected, directly or indirectly, to an end of the waist support frame 20. The driving modules 35 and 45 may be directly or indirectly connected to the waist support frame 20.

In an embodiment, a processor, memory (e.g., memory 514 of FIGS. 5A and 5B), an IMU (e.g., the IMU 135 of FIG. 1 and an IMU 522 of FIG. 5B), a communication module (e.g., a communication module 516 of FIGS. 5A and 5B), a sound output module (e.g., the sound output module 550 of FIGS. 5A and 5B), and a battery (not shown) may be disposed in the base body 80. The base body 80 may protect the components inside the base body 80. The processor may generate a control signal for controlling an operation of the exercise assistance device 100. The processor may control a motor (or an actuator) of the driving modules 35 and 45 configured to generate torque based on electrical energy stored in the battery. The processor and the memory may be included in control circuitry. The control circuitry may further include power supply circuitry configured to supply power from the battery to each of the components of the exercise assistance device 100.

In an embodiment, the exercise assistance device 100 may include a sensor module (not shown) (e.g., the sensor module 520 of FIG. 5A) configured to obtain sensor data from at least one sensor. The sensor module may obtain sensor data including motion information of the user and/or motion information of the components of the exercise assistance device 100. For example, the sensor module may include an IMU (e.g., the IMU 135 of FIG. 1 and the IMU 522 of FIG. 5B) configured to measure a motion value of the upper body of the user or a motion value of the waist support frame 20 and an angle sensor (e.g., the angle sensor 125 of FIG. 1, a first angle sensor 524 and a second angle sensor 524-1 of FIG. 5B) configured to measure a hip joint angle value of the user or a motion value of the torque transmission frame 50 or 55, but embodiments are not limited thereto. For example, the sensor module may further include at least one of a position sensor, a temperature sensor, a biosignal sensor, a distance sensor, or a proximity sensor.

The waist fastening portion 60 may be directly or indirectly connected to the waist support frame 20 and may fasten the waist support frame 20 to the waist of the user. The waist fastening portion 60 may include, for example, a pair of belts.

The driving module 35 or 45 may generate an external force (or torque) applied to the body of the user based on the control signal generated by the processor. For example, the driving module 35 or 45 may generate an assistance force or a resistance force applied to the legs of the user. In an embodiment, the driving modules 35 and 45 may include a first driving module 45 disposed at a position corresponding to a right hip joint of the user and a second driving module 35 disposed at a position corresponding to a left hip joint of the user. The first driving module 45 may include a first actuator and a first joint member and the second driving module 35 may include a second actuator and a second joint member. The first actuator may provide power to be transmitted to the first joint member, and the second actuator may provide power to be transmitted to the second joint member. The first actuator and the second actuator may each include a motor configured to generate power (or torque) by receiving power from the battery. When the motor is driven as the power is supplied to the motor, the motor may generate a force (an assistance force) for assisting a body motion of the user or a force (a resistance force) for hindering a body motion of the user. In an embodiment, the control module may adjust the strength and direction of the force generated by the motor by adjusting a voltage and/or a current supplied to the motor.

In an embodiment, the first joint member and the second joint member may receive power from the first actuator and the second actuator, respectively, and may apply an external force to the body of the user based on the received power. In an embodiment, the first joint member and the second joint member may be disposed at positions corresponding to the joints of the user, respectively. One side of the first joint member may be directly or indirectly connected to the first actuator, and the other side of the first joint member may be directly or indirectly connected to the first torque transmission frame 55. The first joint member may be rotated by the power received from the first actuator. An encoder or a Hall sensor that may operate as an angle sensor to measure a rotation angle (corresponding to a joint angle of the user) of the first joint member or the first torque transmission frame 55 may disposed on one side of the first joint member. One side of the second joint member may be connected, directly or indirectly, to the second actuator, and the other side of the second joint member may be connected, directly or indirectly, to the second torque transmission frame 50. The second joint member may be rotated by the power received from the second actuator. An encoder or a Hall sensor that may operate as an angle sensor to measure a rotation angle of the second joint member or the second torque transmission frame 50 may be disposed on one side of the second joint member.

In an embodiment, the first actuator may be disposed in a lateral direction of the first joint member, and the second actuator may be disposed in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, embodiments are not limited thereto, and an actuator and a joint member may share a rotation axis. In an embodiment, each actuator may be spaced apart from a corresponding joint member. In this case, the driving modules 35 and 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited by the positional relationship between an actuator and a joint member and the power transmission structure described above.

In an embodiment, when the exercise assistance device 100 is worn on the legs of the user, the first torque transmission frame 55 and the second torque transmission frame 50 may transmit torque generated by the first driving module 45 and the second driving module 35 to the body (e.g., the legs) of the user, respectively. The transmitted torque may function as an external force applied to a leg motion of the user. Respective ends of the first torque transmission frame 55 and the second torque transmission frame 50 may be directly or indirectly connected to the joint member and rotate. As the other ends of the first torque transmission frame 55 and the second torque transmission frame 50 are directly or indirectly connected to the first thigh fastening portion 2 and the second thigh fastening portion 1, the first torque transmission frame 55 and the second torque transmission frame 50 may transmit the torque generated by the first driving module 45 and the second driving module 35 to the thighs of the user while supporting the thighs of the user. For example, the first torque transmission frame 55 and the second torque transmission frame 50 may push or pull the thighs of the user. The first torque transmission frame 55 and the second torque transmission frame 50 may extend in a longitudinal direction of the thighs of the user or may be bent and enclose at least some portions of the circumferences of the thighs of the user. The first torque transmission frame 55 may be a torque transmission frame for transmitting torque to the right leg of the user, and the second torque transmission frame 50 may be a torque transmission frame for transmitting torque to the left leg of the user.

The first thigh fastening portion 2 and the second thigh fastening portion 1 may be directly or indirectly connected to the first torque transmission frame 55 and the second torque transmission frame 50, respectively, and may fasten the exercise assistance device 100 to the legs (specifically, thighs) of the user. The first thigh fastening portion 2 may be a thigh fastening portion for fastening the exercise assistance device 100 to the right thigh of the user, and the second thigh fastening portion 1 may be a thigh fastening portion for fastening the exercise assistance device 100 to the left thigh of the user.

In an embodiment, the first thigh fastening portion 2 may include a first cover, a first fastening frame, and a first strap, and the second thigh fastening portion 1 may include a second cover, a second fastening frame, and a second strap. The first cover and the second cover may apply torque generated by the first driving module 45 and the second driving module 35 to the thighs of the user. For example, the first cover and the second cover may be respectively disposed on respective sides of the thighs of the user and may push or pull the thighs of the user. The first cover and the second cover may be disposed in the circumferential directions of the thighs of the user. The first cover and the second cover may extend to both sides from the other ends of the first torque transmission frame 55 and the second torque transmission frame 50, and may include curved surfaces corresponding to the thighs of the user. The respective ends of the first cover and the second cover may be directly or indirectly connected to the first fastening frame and the second fastening frame. The other ends of the first cover and the second cover may be directly or indirectly connected to the first strap and the second strap.

For example, the first fastening frame and the second fastening frame may be disposed to enclose at least some portions of the circumferences of the thighs of the user, thereby preventing or reducing chances of the thighs of the user from being separated from the exercise assistance device 100 or decreasing a possibility of separation. The first fastening frame may have a fastening structure that connects the first cover to the first strap, and the second fastening frame may have a fastening structure that connects the second cover to the second strap.

The first strap may enclose the remaining portion of the circumference of the right thigh of the user that is not covered by the first cover and the first fastening frame, and the second strap may enclose the remaining portion of the circumference of the left thigh of the user that is not covered by the second cover and the second fastening frame. The first and second straps may include, for example, an elastic material (e.g., a band).

FIGS. 5A and 5B are diagrams illustrating a configuration of a control system of an exercise assistance device according to an embodiment.

Referring to FIG. 5A, an exercise assistance device may be controlled by a control system 500. The control system 500 may include a control module 510 (including control circuitry such as processing circuitry of a processor), a communication module 516 including communication circuitry, a sensor module 520 including at least one sensor, a driving module 530, an input module 540 including circuitry, and the sound output module 550 including a speaker. The driving module 530 may include a motor 534 configured to generate power (e.g., torque), and a motor driver circuit 532 to drive the motor 534. Although FIG. 5A illustrates the driving module 530 including one motor driver circuit 532 and one motor 534, this is only an example. Referring to FIG. 5B, in a control system 500-1, a plurality (e.g., two or more) of motor driver circuits 532 and 532-1 and a plurality (e.g., two or more) of motors 534 and 534-1 may be provided. The driving module 530 including the motor driver circuit 532 and the motor 534 may correspond to the first driving module 45 of FIG. 3, and a driving module 530-1 including the motor driver circuit 532-1 and the motor 534-1 may correspond to the second driving module 35 of FIG. 3. The following descriptions of the motor driver circuit 532 and the motor 534 may also be respectively applicable to the motor driver circuit 532-1 and the motor 534-1 shown in FIG. 5B.

Referring back to FIG. 5A, the sensor module 520 may include at least one sensor configured to obtain sensor data. The sensor module 520 may transmit the obtained sensor data to the control module 510. The sensor module 520 may include a sensor configured to obtain sensor data including motion information of a user or motion information of the exercise assistance device 100. The sensor module 520 may include the IMU 522, a first angle sensor 524, and a second angle sensor 524-1 as shown in FIG. 5B. The IMU 522 may measure an upper body motion value of the user. For example, the IMU 522 may sense acceleration and angular velocity of an X-axis, a Y-axis, and a Z-axis according to a motion of the user. The motion value of the upper body of the user may correspond to a motion value of a waist support frame of the exercise assistance device 100. The first angle sensor 524 and the second angle sensor 524-1 may measure a hip joint angle according to the leg motion of the user. The first angle sensor 524 may sense the hip joint angle of the right leg of the user, and the second angle sensor 524-1 may sense the hip joint angle of the left leg of the user. The first angle sensor 524 and the second angle sensor 524-1 may include, for example, an encoder and/or a Hall sensor. The hip joint angle of the right leg sensed by the first angle sensor 524 may correspond to a motion value (e.g., a rotation angle value) of the first torque transmission frame 55 of the exercise assistance device 100, and the hip joint angle of the left leg sensed by the second angle sensor 524-1 may correspond to a motion value (e.g., a rotation angle value) of the second torque transmission frame 50 of the exercise assistance device 100.

In an embodiment, the sensor module 520 may further include a position sensor configured to obtain a position value of the exercise assistant device 100, a proximity sensor configured to sense the proximity of an object, a biosignal sensor configured to detect a biosignal of the user, and/or a temperature sensor configured to measure an ambient temperature.

The input module 540 may receive a command or data to be used by a component (e.g., the processor 512) of the exercise assistance device 100 from the outside (e.g., a user) of the exercise assistance device 100. The input module 540 may include, for example, a key (e.g., a button), a touch screen, and/or a microphone.

The sound output module 550 may output a sound signal to the outside of the exercise assistance device 100. The sound output module 550 may include a guide sound signal (e.g., a driving start sound or an operation error notification sound) and a speaker for playing music content or a guide voice.

In an embodiment, the control system 500 may further include a battery (not shown) configured to supply power to each component of the exercise assistance device 100. The exercise assistance device 100 may convert the power of the battery into power suitable for an operating voltage of each component of the exercise assistance device and supply the converted power to each component.

The driving module 530 may generate an external force to be applied to a leg of the user under the control of the control module 510. The driving module 530 may be in a position corresponding to a position of a hip joint of the user and may generate torque to be applied to the leg of the user based on a control signal generated by the control module 510. The control module 510 may transmit the control signal to the motor driver circuit 532, and the motor driver circuit 532 may control an operation of the motor 534 by generating a current signal (or a voltage signal) corresponding to the control signal and supplying the current signal (or the voltage signal) to the motor 534. The current signal may not be supplied to the motor 534 according to the control signal. When the current signal is supplied to the motor 534, and the motor is driven, the motor 534 may generate an assistance force to assist a leg motion of the user or a resistance force to impede the leg motion of the user.

The control module 510 may control the overall operation of the exercise assistance device 100 and generate a control signal to control each component of the exercise assistance device 100. The control module 510 may include a processor 512 and memory 514.

The processor 512 may execute, for example, software to control at least one other component (e.g., a hardware or software component) of the wearable device directly or indirectly connected to the processor 512, and perform a variety of data processing or computation. The processor 512 may include at least one processor. According to an embodiment, as at least a part of data processing or computation, the processor 512 may store instructions or data received from another component (e.g., the communication module 516) in the memory 514, may process the instructions or the data stored in the memory 514, and may store result data in the memory 514. According to an embodiment, the processor 512 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently of, or in conjunction with the main processor. The auxiliary processor may be implemented separately from the main processor or as a part of the main processor.

The memory 514 may store a variety of data used by at least one component (e.g., the processor 512) of the control module 510. The variety of data may include, for example, software, sensor data, input data or output data for instructions related thereto. The memory 514 may include volatile memory or non-volatile memory.

The communication module 516 may support establishing a direct (e.g., wired) communication channel or a wireless communication channel between the control module 510 and another component of the exercise assistance device 100 or an external electronic device (e.g., the electronic device 210 or the other wearable device 220 of FIG. 2) and performing communication via the established communication channel. For example, the communication module 516 may transmit the sensor data obtained by the sensor module 520 to an external electronic device (e.g., the electronic device 210 of FIG. 2) and receive a control signal from the external electronic device. According to an embodiment, the communication module 516 may include one or more CPs that are operable independently of the processor 512 and that support a direct (e.g., wired) communication or a wireless communication. According to an embodiment, the communication module 516 may include a wireless communication module (e.g., a cellular communication module, a short-range wireless communication module, or a global navigation satellite system (GNSS) communication module) and/or a wired communication module. For example, the communication module 516 may communicate with another device via a short-range communication network, such as Bluetooth, Wi-Fi, an ANT, or infrared data association (IrDA), or a long-range communication network, such as a legacy cellular network, a 5G network, a next-generation communication network, the Internet, or a computer network (e.g., a local area network (LAN) or a wide area network (WAN)).

The haptic module 560 may provide haptic feedback to the user under the control of the processor 512. The haptic module 560 may include one or a plurality of haptic actuators. A haptic actuator may include, for example, a piezo actuator, a bander type actuator, and/or a vibration motor-based actuator.

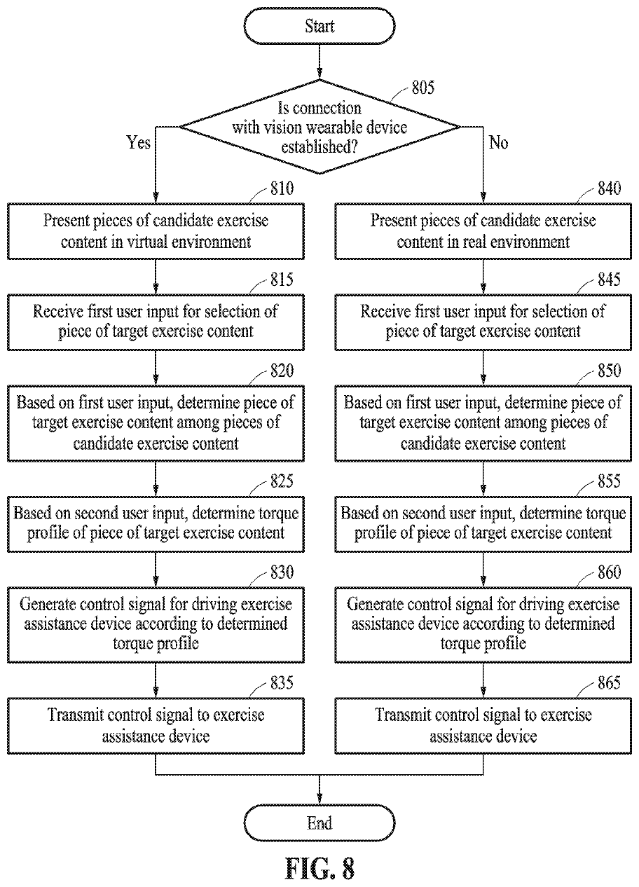

In an embodiment, when the exercise assistance device 100 is wirelessly connected to the electronic device 210 and operates, the exercise assistance device 100 may be operated under the control of the electronic device 210. The exercise assistance device 100 may receive a control signal for executing a piece of target exercise content selected by the user from the electronic device 210 through the communication module 516. The control signal may include torque profile-related information regarding how the exercise assistance device 100 needs to generate torque over time. The control signal may be generated by the electronic device 210 and transmitted to the exercise assistance device 100, for example, according to the process of FIG. 8. Based on the received control signal, the processor 512 may control the driving module 530 to generate torque from the driving module 530. Based on a hip joint angle measured by an angle sensor of the sensor module 520, the processor 512 may control output torque of the motor 534. The control of the output torque of the motor 534 based on the hip joint angle may be initiated when the motion of a leg of the user is detected. The angle sensor may measure the angle of the hip joint (or a leg) relative to a reference plane. In an embodiment, the processor 512 may determine a hip joint angular velocity by calculating a change in a hip joint angle over time and may determine a hip joint angular acceleration by differentiating the hip joint angular velocity. The processor 512 may determine an angular difference between the hip joint angles measured for both hip joints and determine an angular velocity difference between the hip joint angular velocities determined for both hip joints. The processor 512 may determine an angular acceleration difference between the angular accelerations of both hip joints determined for both hip joints. According to a torque profile defined and/or indicated by the control signal received from the electronic device 210, based on at least one of the hip joint angle, hip joint angular velocity, hip joint angular acceleration, the angular difference between the angles of both hip joints, the angular velocity difference between the angular velocities of both hip joints, and the angular acceleration difference between the angular accelerations of both hip joints of the user, the processor 512 may determine output torque of the motor 534.

Based on the control signal received from the electronic device 210, the processor 512 may control the sound output module 550 to output a sound signal or control the haptic module 560 to provide haptic feedback. The processor 512 may control the communication module 516 to transmit sensor data obtained by the sensor module 520 to the electronic device 210.

In an embodiment, the exercise assistance device 100 may operate without torque control by the electronic device 210. The exercise assistance device 100 may include the driving module 530 including the motor 534 that generates torque, a torque transmission frame (e.g., the torque transmission frames 50 and 55 of FIGS. 3 and 4) for transmitting the generated torque to a leg of the user, a thigh fastening portion (e.g., the thigh fastening portions 1 and 2 of FIGS. 3 and 4) connected to the torque transmission frame and for connecting the torque transmission frame to the leg of the user, the sensor module 520 that obtains sensor data including motion information of the user, and the processor 512. The exercise assistance device 100 may further include a communication module that communicates with a vision wearable device that provides a piece of visual content to the user. The processor 512 may control to present the user with a list of pieces of executable candidate exercise content. For example, the processor 512 may control to output a guide voice that provides guidance on what pieces of candidate exercise content are executable in the current state through the sound output module 550, wireless earphones (e.g., the wireless earphones 222 of FIG. 2), or a vision wearable device (e.g., the vision wearable device 226 of FIG. 2). The processor 512 may determine whether the exercise assistance device 100 is connected to the vision wearable device (e.g., the vision wearable device 226 of FIG. 2) and based on whether the exercise assistance device 100 is connected to the vision wearable device, determine pieces of candidate exercise content. In response to the exercise assistance device 100 being connected to the vision wearable device, the processor 512 may control to provide the user with a list of pieces of candidate exercise content including at least one of a piece of AR content and a piece of VR content. Based on a first user input including a selection of a piece of target exercise content, the processor 512 may determine the piece of target exercise content to be executed among the pieces of candidate exercise content using the exercise assistance device 100. The first user input may be input through the input module 540. The first user input may be, for example, a voice input of the user, a key/button input on the exercise assistance device 100, or a touch input. The processor 512 may control to present a list of candidate exercise experience attributes associated with the piece of target exercise content. For example, the processor 512 may control to output a guide voice that provides guidance on what candidate exercise experience attributes are associated with the piece of target exercise content through the sound output module 550, the wireless earphones, or the vision wearable device. Based on a second user input including a selection of an exercise experience attribute associated with the piece of target exercise content, the processor 512 may determine a torque profile of the piece of target exercise content. The second user input may be input through the input module 540. The second user input may be, for example, a voice input of the user, a key/button input on the exercise assistance device 100, or a touch input. When the piece of target exercise content is or includes a piece of exercise content using a single leg (e.g., single-leg fitness exercise), the second user input may include a selection of at least one of the exercise experience attributes respectively corresponding to the hip joint angle, hip joint angular velocity, and hip joint angular acceleration of the user. When the piece of target exercise content is or includes a piece of exercise content using both legs (e.g., walking in place, walking on flat ground, interval walking, walking in water with waves, and walking/running on a sandy beach with depressed terrain), the second user input may include a selection of at least one of the exercise experience attributes respectively corresponding to the angular difference between the angles of both hip joints, the angular velocity difference between the angular velocities of both hip joints, and the angular acceleration difference between the angular accelerations of both hip joints of the user. According to the selected exercise experience attribute, based on at least one of the hip joint angle, hip joint angular velocity, hip joint angular acceleration of the user wearing the exercise assistance device 100, angular difference between the angles of both hip joints, the angular velocity difference between the angular velocities of both hip joints, and the angular acceleration difference between the angular accelerations of both hip joints of the user, the processor 512 may determine a torque profile.

Based on the sensor data obtained by the sensor module 520 and the determined torque profile, the processor 512 may control the output torque of the motor 534. In an embodiment, the processor 512 may control the output torque of the motor 534 according to one corresponding to the selected exercise experience attribute among a first torque profile based on the hip joint angle of the user, a second torque profile based on the hip joint angular velocity of the user, a third torque profile based on the angular acceleration of the user, a fourth torque profile based on the angular difference between the angles of both hip joints of the user, a fifth torque profile based on the angular velocity difference between the angular velocities of both hip joints of the user, and a sixth torque profile based on the angular acceleration difference between the angular accelerations of both hip joints of the user. For example, when the selected exercise experience attribute corresponds to the first torque profile, the processor 512 may control the output torque of the motor 534 by applying the hip joint angle measured by the angle sensor of the sensor module 520 to the first torque profile. For example, the processor 512 may determine an output torque value of the motor 534 by applying the hip joint angle to a torque profile as shown in Equation 1 below. When the selected exercise experience attribute corresponds to the second torque profile, the processor 512 may determine the hip joint angular velocity based on the hip joint angle measured by the angle sensor and apply the determined hip joint angular velocity to the second torque profile to control the output torque of the motor 534. The hip joint angular velocity may be determined by calculating a change in the hip joint angle during a unit time. For example, the processor 512 may determine the output torque value of the motor 534 by applying the hip joint angular velocity to a torque profile as shown in Equation 2 below. When the selected exercise experience attribute corresponds to the third torque profile, the processor 512 may determine the hip joint angular acceleration based on the hip joint angle measured by the angle sensor and apply the determined hip joint angular acceleration to the third torque profile to control the output torque of the motor 534. The hip joint angular velocity may be determined by calculating the change in hip joint angle during a unit time, and the hip joint angular acceleration may be determined by differentiating the hip joint angular velocity. For example, the processor 512 may determine the output torque value of the motor 534 by applying the hip joint angular acceleration to a torque profile as shown in Equation 3 below. When the selected exercise experience attribute corresponds to the fourth torque profile, the processor 512 may determine the angular difference between the angles of both hip joints measured by the angle sensor and apply the determined angular difference to the fourth torque profile to control the output torque of the motor 534. For example, the processor 512 may determine the output torque value of the motor 534 by applying the hip joint angular difference to a torque profile as shown in Equation 6 below. When the selected exercise experience attribute corresponds to the fifth torque profile, based on the angles of both hip joints measured by the angle sensor, the processor 512 may determine the hip joint angular velocities of both hip joints and control the output torque of the motor 534 by applying the angular velocity difference between the hip joint angular velocities of both hip joints to the fifth torque profile. For example, the processor 512 may determine the output torque value of the motor 534 by applying the hip joint angular velocity difference to a torque profile as shown in Equation 7 below. When the selected exercise experience attribute corresponds to the sixth torque profile, based on the angles of both hip joints measured by the angle sensor, the processor 512 may determine the angular accelerations of both hip joints and control the output torque of the motor 534 by applying the angular acceleration difference between the angular accelerations of both hip joints to the sixth torque profile. For example, the processor 512 may determine the output torque value of the motor 534 by applying the hip joint angular acceleration difference to a torque profile as shown in Equation 8 below.

In an embodiment, according to any one of a seventh torque profile based on at least two of the hip joint angle, hip joint angular velocity, and hip joint angular acceleration of the user and an eighth torque profile based on at least two of the angular difference between the angles of both hip joints, the angular velocity difference between the angular velocities of both hip joints, and the angular acceleration difference between the angular accelerations of both hip joints of the user, the processor 512 may control the output torque of the motor 534. The seventh torque profile may be based on, for example, the sum of or difference between at least two of the hip joint angle, hip joint angular velocity, and hip joint angular acceleration of the user. When the seventh torque profile corresponding to the selected exercise experience attribute is based on the difference between the hip joint angle and the hip joint angular velocity as shown in Equation 4 below, the processor 512 may control the output torque of the motor 534 by applying the difference between the hip joint angle and the hip joint angular velocity measured by the angle sensor of the sensor module 520 to the seventh torque profile. When the seventh torque profile corresponding to the selected exercise experience attribute is based on the sum of the hip joint angle and the hip joint angular velocity as shown in Equation 5 below, the processor 512 may control the output torque of the motor 534 by applying the sum of the hip joint angle and the hip joint angular velocity measured by the angle sensor of the sensor module 520 to the seventh torque profile. The eighth torque profile may be based on, for example, the sum of or difference between at least two of the angular difference between the angles of both hip joints, the angular velocity difference between the angular velocities of both hip joints, and the angular acceleration difference between the angular accelerations of both hip joints of the user. When the eighth torque profile corresponding to the selected exercise experience attribute is based on the angular difference between the angles of both hip joints and the angular velocity difference between the angular velocities of both hip joints as shown in Equations 9 and 10, the processor 512 may control the output torque of the motor 534 by applying, to the eighth torque profile, the angular difference between the angles of both hip joints and the angular velocity difference between the angular velocities of both hip joints of the user. The torque profile shown in Equation 9 may be based on the angular difference between the angles of both hip joints and the angular velocity difference between the angular velocities of both hip joints. The torque profile shown in Equation 10 may be based on the sum of the angular difference between the angles of both hip joints and the angular velocity difference between the angular velocities of both hip joints.

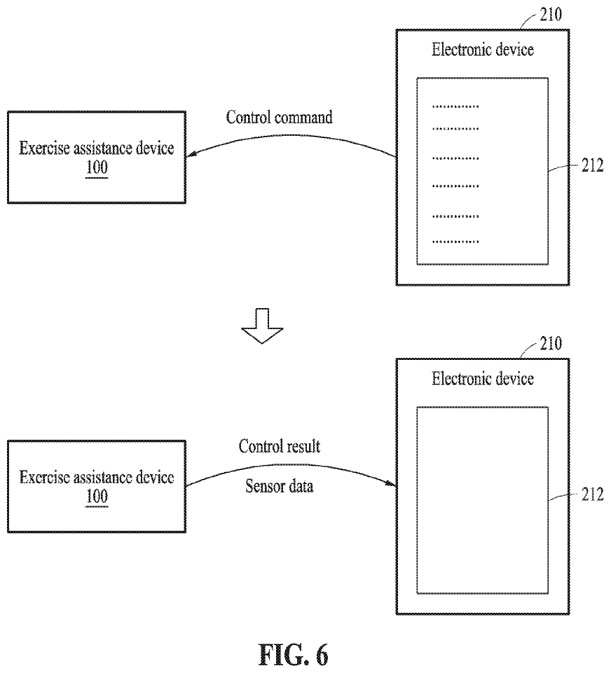

FIG. 6 is a diagram illustrating an interaction between an exercise assistance device and an electronic device, according to an embodiment.

Referring to FIG. 6, the exercise assistance device 100 may communicate with the electronic device 210. For example, the electronic device 210 may be a user terminal of a user using the exercise assistance device 100. According to an embodiment, the exercise assistance device 100 and the electronic device 210 may be connected to each other via short-range wireless communication (e.g., Bluetooth communication and Wi-Fi communication).

In an embodiment, the electronic device 210 may check the status of the exercise assistance device 100 or execute an application to control or operate the exercise assistance device 100. A screen of a UI may be displayed to control an operation of the exercise assistance device 100 or determine an operation mode of the exercise assistance device 100 on a display 212 of the electronic device 210 through the execution of the application. The UI may be, for example, a GUI.

In an embodiment, the user may input an instruction for controlling the operation of the exercise assistance device 100 (e.g., an instruction to execute a walking assistance mode or an exercise assistance mode) or change settings of the exercise assistance device 100 through a GUI screen on the display 212 of the electronic device 210. The electronic device 210 may generate a control signal corresponding to an operation control instruction or setting change instruction input by a user and may transmit the generated control signal to the exercise assistance device 100.

In an embodiment, the electronic device 210 may output a list of pieces of candidate exercise content to the user through a UI and receive a user input for a piece of target exercise content that the user desires to perform among the pieces of candidate exercise content. Additionally, the electronic device 210 may output a list of candidate exercise experience attributes for the piece of target exercise content to the user through a UI and receive a user input for a target exercise experience attribute that the user desires to experience among the candidate exercise experience attributes. The electronic device 210 may determine a torque profile to be applied to the exercise assistance device 100 based on the piece of target exercise content and the target exercise experience attribute and generate a control signal to control the exercise assistance device 100 according to the torque profile. The electronic device 210 may transmit the generated control signal to the exercise assistance device 100. The transmitted control signal may include information about the torque profile.

The exercise assistance device 100 may operate according to the received control signal and may transmit a control result according to the control signal and/or sensor data measured by a sensor module of the exercise assistance device 100 to the electronic device 210. The exercise assistance device 100 may transmit the sensor data to the electronic device 210 periodically or non-periodically. The electronic device 210 may provide the user with result information (e.g., current exercise state information, exercise result information, exercise posture assessment information, and physical ability assessment information) derived by analyzing the control result and/or the sensor data through the GUI screen.

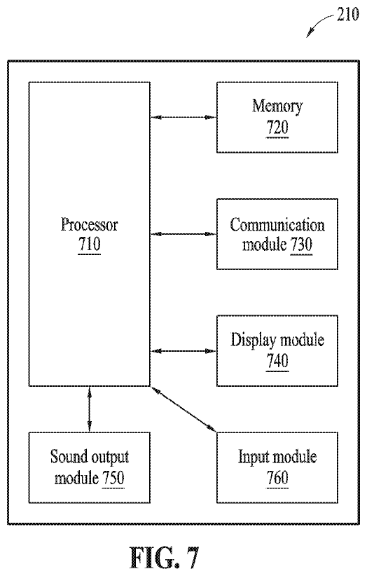

FIG. 7 is a diagram illustrating a configuration of an electronic device according to an embodiment.

Referring to FIG. 7, the electronic device 210 may include a processor 710, memory 720, a communication module 730, a display module 740, a sound output module 750, and an input module 760. In an embodiment, the electronic device 210 may omit at least one (e.g., the sound output module 750) of the components or may include one or more other components (e.g., a sensor module including one or more sensors, a haptic module including a haptic actuator for providing haptic feedback, and a battery for power supply).

The processor 710 may control at least one other component (e.g., a hardware or software component) of the electronic device 210 and may perform a variety of data processing or computation. The processor 710 may include at least one processor. According to an embodiment, as at least a part of data processing or computation, the processor 710 may store instructions or data received from another component (e.g., the communication module 730) in the memory 720, process the instructions or the data stored in the memory 720, and store result data in the memory 720. The processor 710 may include a main processor (e.g., a CPU or an AP) or an auxiliary processor (e.g., a GPU), an NPU, an ISP, a sensor hub processor, or a CP) that is operable independently of or in conjunction with the main processor.

The memory 720 may store various pieces of data used by at least one component (e.g., the processor 710 or the communication module 730) of the electronic device 210. The data may include, for example, a program (e.g., an application) and input data or output data for an instruction related thereto. The memory 720 may include at least one instruction executable by the processor 710. The memory 720 may include, for example, volatile memory or non-volatile memory. In this case, each processor may include processing circuitry.

The communication module 730 may support establishing a direct (e.g., wired) communication channel or a wireless communication channel between the electronic device 210 and another electronic device (e.g., the exercise assistance device 100, the other wearable device 220, or the server 230) and performing communication via the established communication channel. The communication module 730 may include communication circuitry for performing a communication function. The communication module 730 may include one or more CPs that are operable independently of the processor 710 (e.g., an AP) and that support a direct (e.g., wired) communication or a wireless communication. In an embodiment, the communication module 730 may include a wireless communication module (e.g., a Bluetooth™ communication module, a cellular communication module, a Wi-Fi communication module, or a GNSS communication module) that performs wireless communication or a wired communication module (e.g., a LAN communication module or a power line communication (PLC) module). For example, the communication module 730 may transmit a control signal to the exercise assistance device 100 and receive at least one of sensor data including body motion information of a user wearing the exercise assistance device 100, state data of the exercise assistance device 100, or control result data corresponding to the control signal from the exercise assistance device 100.

The display module 740 may visually provide information to the outside (e.g., the user) of the electronic device 210. The display module 740 may include, for example, a liquid-crystal display (LCD) or organic light-emitting diode (OLED) display, a hologram device, or a projector device. The display module 740 may further include control circuitry to control the driving of the display. The display module 740 may output a UI screen for controlling the exercise assistance device 100 or providing various pieces of information (e.g., exercise assessment information and setting information of the exercise assistance device 100).

The sound output module 750 may output a sound signal to the outside of the electronic device 210. The sound output module 750 may include a speaker configured to play back a guide sound signal (e.g., an operation start sound or an operation error alarm), music content, or a guide voice based on the state of the exercise assistance device 100. For example, when it is determined that the exercise assistance device 100 is not normally worn on the body of the user, the sound output module 750 may output a guide voice for notifying the user of abnormal wearing of the exercise assistance device 100 or guiding the user to wear the exercise assistance device 100 normally.

The input module 760 may receive, from the outside (e.g., the user) of the electronic device 210, a command or data to be used by a component (e.g., the processor 710) of the electronic device 210. The input module 760 may include input component circuitry and receive a user input. The input module 760 may include, for example, a key (e.g., a button), touch recognition circuitry for recognizing a touch on a screen, and/or a microphone.

The electronic device 210 according to an embodiment may include the processor 710 and the communication module 730 that communicates with the exercise assistance device 100. The electronic device 210 may further include the display module 740 and the input module 760. The processor 710 may control to present the user with a list of pieces of executable candidate exercise content. The list of pieces of executable candidate exercise content may be provided to the user through visual means of a UI or through auditory means of a voice guide. When the list is provided through visual means, the display module 740 may output the list of pieces of candidate exercise content through the UI. When the list is provided through auditory means, the processor 710 may control to output a voice guide for the list of pieces of candidate exercise content. The voice guide may be output from the sound output module 750, wireless earphones (e.g., the wireless earphones 222 of FIG. 2), or a vision wearable device (e.g., the vision wearable device 226 of FIG. 2).

The processor 710 may determine whether the electronic device 210 is connected to the vision wearable device (e.g., the vision wearable device 226 of FIG. 2) that provides a piece of visual content to the user and determine pieces of candidate exercise content based on whether the electronic device 210 is connected to the vision wearable device. In an embodiment, in response to the electronic device 210 being connected to the vision wearable device, the processor 710 may control to provide the user with the list of pieces of candidate exercise content including at least one of a piece of AR content and a piece of VR content. In an embodiment, in response to the electronic device 210 being connected to the vision wearable device, the processor 710 may control to provide the user with the list of pieces of candidate exercise content that operate in a resistance mode that provides resistance to the body motion of the user. In an embodiment, in response to the electronic device 210 not being connected to the vision wearable device, the processor 710 may control to provide the user with the list of pieces of candidate exercise content that operate in an assistance mode to assist the body motion of the user. Based on a first user input including a selection of any one of the pieces of candidate exercise content using the exercise assistance device 100, the processor 710 may determine a piece of target exercise content to be executed. The first user input may be input through the input module 760. The first user input may be, for example, a voice input of the user, a key/button input of the electronic device 210, or a touch input on a touch screen.

The processor 710 may control to present a list of candidate exercise experience attributes associated with the piece of target exercise content. For example, the processor 710 may control the display module 740 to output the list of candidate exercise experience attributes associated with the piece of target exercise content through a UI. In another example, the processor 710 control to output a guide voice for the list of candidate exercise experience attributes associated with the piece of target exercise content through the sound output module 750, the wireless earphones, or the vision wearable device. Based on a second user input including a selection of an exercise experience attribute associated with the piece of target exercise content, the processor 710 may determine a torque profile of the piece of target exercise content. The second user input may be input through the input module 760. The second user input may be, for example, a voice input of the user, a key/button input of the electronic device 210, or a touch input on a touch screen. When the piece of target exercise content is or includes a piece of exercise content using a single leg (e.g., single-leg fitness exercise), the second user input may include a selection of at least one of the exercise experience attributes respectively corresponding to the hip joint angle, hip joint angular velocity, and hip joint angular acceleration of the user. When the piece of target exercise content is or includes a piece of exercise content using both legs (e.g., walking in place, walking on flat ground, interval walking, walking in water with waves, and walking/running on a sandy beach with depressed terrain), the second user input may include a selection of at least one of the exercise experience attributes respectively corresponding to the angular difference between the angles of both hip joints, the angular velocity difference between the angular velocities of both hip joints, and the angular acceleration difference between the angular accelerations of both hip joints of the user.

According to the selected exercise experience attribute, based on at least one of the hip joint angle, hip joint angular velocity, hip joint angular acceleration of the user wearing the exercise assistance device 100, the angular difference between the angles of both hip joints, the angular velocity difference between the angular velocities of both hip joints, and the angular acceleration difference between the angular accelerations of both hip joints of the user, the processor 710 may determine a torque profile. The processor 710 may generate a control signal to drive the exercise assistance device 100 according to the determined torque profile.

In an embodiment, the processor 710 may generate a control signal for controlling the exercise assistance device 100 according to one corresponding to the selected exercise experience attribute among a first torque profile based on the hip joint angle of the user, a second torque profile based on the hip joint angular velocity of the user, a third torque profile based on the angular acceleration of the user, a fourth torque profile based on the angular difference between the angles of both hip joints of the user, a fifth torque profile based on the angular velocity difference between the angular velocities of both hip joints of the user, and a sixth torque profile based on the angular acceleration difference between the angular accelerations of both hip joints of the user. For example, when the selected exercise experience attribute corresponds to the first torque profile, the processor 710 may generate a control signal that causes the exercise assistance device 100 to control output torque of a motor (e.g., the motor 534 of FIGS. 5A and 5B) of the exercise assistance device 100 by applying a hip joint angle measured by an angle sensor to the first torque profile. When the selected exercise experience attribute corresponds to the second torque profile, the processor 710 may generate a control signal that causes the exercise assistance device 100 to control the output torque of the motor of the exercise assistance device 100 by applying a hip joint angular velocity to the second torque profile. When the selected exercise experience attribute corresponds to the third torque profile, the processor 710 may generate a control signal that causes the exercise assistance device 100 to control the output torque of the motor of the exercise assistance device 100 by applying a hip joint angular acceleration to the third torque profile. When the selected exercise experience attribute corresponds to the fourth torque profile, the processor 710 may generate a control signal that causes the exercise assistance device 100 to control the output torque of the motor (e.g., the motor 534 and the motor 534-1 of FIG. 5B) of the exercise assistance device 100 by applying the angular difference between the angles of both hip joints to the fourth torque profile. When the selected exercise experience attribute corresponds to the fifth torque profile, the processor 710 may generate a control signal that causes the exercise assistance device 100 to control the output torque of the motor of the exercise assistance device 100 by applying the angular velocity difference between the angular velocities of both hip joints to the fifth torque profile. When the selected exercise experience attribute corresponds to the sixth torque profile, the processor 710 may generate a control signal that causes the exercise assistance device 100 to control the output torque of the motor of the exercise assistance device 100 by applying the angular acceleration difference between the angular accelerations of both hip joints to the sixth torque profile.

In an embodiment, according to any one of a seventh torque profile based on at least two of the hip joint angle, hip joint angular velocity, and hip joint angular acceleration of the user and an eighth torque profile based on at least two of the angular difference between the angles of both hip joints, the angular velocity difference between the angular velocities of both hip joints, and the angular acceleration difference between the angular accelerations of both hip joints of the user, the processor 710 may generate a control signal for controlling the exercise assistance device 100. The seventh torque profile may be based on, for example, the sum of or difference between at least two of the hip joint angle, hip joint angular velocity, and hip joint angular acceleration of the user. When the seventh torque profile corresponding to the selected exercise experience attribute is based on the difference between the hip joint angle and the hip joint angular velocity as shown in Equation 4 below, the processor 710 may generate a control signal that causes the exercise assistance device 100 to control the output torque of the motor of the exercise assistance device 100 by applying the difference between the hip joint angle and the hip joint angular velocity of the user to the seventh torque profile. When the seventh torque profile corresponding to the selected exercise experience attribute is based on the sum of the hip joint angle and the hip joint angular velocity as shown in Equation 5 below, the processor 710 may generate a control signal that causes the exercise assistance device 100 to control the output torque of the motor of the exercise assistance device 100 by applying the sum of the hip joint angle and the hip joint angular velocity of the user to the seventh torque profile. The eighth torque profile may be based on, for example, the sum of or difference between at least two of the angular difference between the angles of both hip joints, the angular velocity difference between the angular velocities of both hip joints, and the angular acceleration difference between the angular accelerations of both hip joints of the user. When the eighth torque profile corresponding to the selected exercise experience attribute is based on the angular difference between the angles of both hip joints and the angular velocity difference between the angular velocities of both hip joints, as shown in Equations 9 and 10, the processor 710 may generate a control signal that causes the exercise assistance device 100 to control the output torque of the motor of the exercise assistance device 100 by applying, to the eighth torque profile, the angular difference between the angles of both hip joints and the angular velocity difference between the angular velocities of both hip joints of the user.

The processor 710 may control the communication module 730 to transmit a control signal to the exercise assistance device 100.

FIG. 8 is a flowchart illustrating operations of a control method of controlling an exercise assistance device performed by an electronic device, according to an embodiment. In an embodiment, at least one of the operations of FIG. 8 may be simultaneously or parallelly performed with one another, and the order of the operations may be changed. In addition, at least one of the operations may be omitted, or another operation may be additionally performed.

Referring to FIG. 8, the processor 710 of the electronic device 210 may present the user with pieces of candidate exercise content using the exercise assistance device 100. Based on whether a connection with a vision wearable device (e.g., the vision wearable device 226 of FIG. 2) is established, the processor 710 may determine pieces of candidate exercise content. First, in operation 805, the processor 710 may determine whether the connection with the vision wearable device is established. In response to the electronic device 210 being connected to the vision wearable device (if “Yes” in operation 805), the processor 710 may present pieces of candidate exercise content in a virtual environment in operation 810. The pieces of candidate exercise content in the virtual environment may include, for example, pieces of resistance-mode-centered exercise content performed in an indoor space. The processor 710 may control to provide a user with a list of pieces of candidate exercise content including at least one of a piece of AR content and a piece of VR content. The pieces of candidate exercise content may further include pieces of candidate exercise content that operate in a resistance mode that provides resistance to the body motion of the user. In an embodiment, the user may be presented with pieces of candidate exercise content in a real environment in addition to the pieces of candidate exercise content in the virtual environment. The list of pieces of candidate exercise content may be provided through a UI, for example, through the display module 740 of the electronic device 210 or may be provided in the form of a voice guide through the sound output module 750 of the electronic device 210 or wireless earphones connected to the electronic device 210.

In operation 815, the input module 760 of the electronic device 210 may receive a first user input including a selection of any one of the pieces of candidate exercise content. The first user input may be, for example, a voice input of the user, a key/button input of the electronic device 210, or a touch input on a touch screen.

In operation 820, the processor 710 may determine a piece of target exercise content to be executed based on the first user input. Based on the first user input, one of the pieces of candidate exercise content may be determined as the piece of target exercise content. The processor 710 may control to present a list of candidate exercise experience attributes associated with the piece of target exercise content in response to a determination of the piece of target exercise content. For example, the processor 710 may control the display module 740 to provide the list of candidate exercise experience attributes associated with the piece of target exercise content through a UI. The list of candidate exercise experience attributes associated with the piece of target exercise content may be provided in the form of a voice guide via wireless earphones connected to the electronic device 210.

The input module 760 may receive a second user input including a selection of an exercise experience attribute associated with the piece of target exercise content. When the piece of target exercise content is or includes a piece of exercise content using a single leg, the second user input may include a selection of at least one of exercise experience attributes respectively corresponding to a hip joint angle, a hip joint angular velocity, and a hip joint angular acceleration of the user. When the piece of target exercise content is or includes a piece of exercise content using both legs, the second user input may include a selection of at least one of exercise experience attributes respectively corresponding to an angular difference between angles of both hip joints, an angular velocity difference between angular velocities of both hip joints, and an angular acceleration difference between angular accelerations of both hip joints of the user. In operation 825, the processor 710 may determine a torque profile of the piece of target exercise content based on the second user input. According to the selected exercise experience attribute, based on at least one of the hip joint angle, hip joint angular velocity, hip joint angular acceleration of the user wearing the exercise assistance device 100, the angular difference between the angles of both hip joints, the angular velocity difference between the angular velocities of both hip joints, and the angular acceleration difference between the angular accelerations of both hip joints of the user, the processor 710 may determine a torque profile. Different torque profiles may be determined based on the selected exercise experience attribute, and the perceived degree of an exercise environment may vary depending on a torque profile to be used. Different torque profiles may be determined depending on the piece of target exercise content selected by the user and the exercise experience attribute selected by the user. Rather than a simple change in torque intensity, by selecting a hip joint angle, a hip joint angular velocity, a hip joint angular acceleration, the angular difference between the angles of both hip joints, the angular velocity difference between the angular velocities of both hip joints, or the angular acceleration difference between the angular accelerations of both hip joints of the user for each type of exercise content, a torque profile of various attributes may be applied to the exercise assistance device 100 to provide the user with various exercise experiences.

In operation 830, the processor 710 may generate a control signal for driving the exercise assistance device 100 according to the determined torque profile. The processor 710 may generate a control signal including an exercise operation instruction and an execution instruction of a torque generation algorithm according to the determined torque profile.

In an embodiment, the processor 710 may generate a control signal for controlling the exercise assistance device 100 according to one corresponding to the selected exercise experience attribute among a first torque profile based on the hip joint angle of the user, a second torque profile based on the hip joint angular velocity of the user, a third torque profile based on the angular acceleration of the user, a fourth torque profile based on the angular difference between the angles of both hip joints of the user, a fifth torque profile based on the angular velocity difference between the angular velocities of both hip joints of the user, and a sixth torque profile based on the angular acceleration difference between the angular accelerations of both hip joints of the user.

In an embodiment, according to any one of a seventh torque profile based on at least two of the hip joint angle, hip joint angular velocity, and hip joint angular acceleration of the user and an eighth torque profile based on at least two of the angular difference between the angles of both hip joints, the angular velocity difference between the angular velocities of both hip joints, and the angular acceleration difference between the angular accelerations of both hip joints of the user, the processor 710 may generate a control signal for controlling the exercise assistance device 100. The seventh torque profile may be based on, for example, the sum of or difference between at least two of the hip joint angle, hip joint angular velocity, and hip joint angular acceleration of the user. The eighth torque profile may be based on, for example, the sum of or difference between at least two of the angular difference between the angles of both hip joints, the angular velocity difference between the angular velocities of both hip joints, and the angular acceleration difference between the angular accelerations of both hip joints of the user.

In operation 835, the processor 710 may transmit the control signal to the exercise assistance device 100 through the communication module 730 of the electronic device 210. The exercise assistance device 100 may determine output torque of a motor (e.g., the motor 534 and the motor 534-1 of FIG. 5B) according to a torque profile indicated in a control signal.

Based on a determination result of operation 805, when the electronic device 210 is not connected to the vision wearable device (if “No” in operation 805), the processor 710 may present the pieces of candidate exercise content in the real environment in operation 840. The pieces of candidate exercise content in the real environment may include, for example, pieces of assistance-mode-centered exercise content performed in a real environment (e.g., indoors, at the beach, and on a sandy beach). A case in which the electronic device 210 is not connected to the vision wearable device may include a case in which the user chooses not to use the vision wearable device. The processor 710 may control to provide the user with the list of pieces of candidate exercise content that operate in the assistance mode to assist the body motion of the user. In operation 845, the input module 760 may receive the first user input including a selection of any one of the pieces of candidate exercise content. In operation 850, the processor 710 may determine a piece of target exercise content to be executed based on the first user input. The processor 710 may control to present the list of candidate exercise experience attributes associated with the piece of target exercise content in response to a determination of the piece of target exercise content. The input module 760 may receive a second user input including a selection of an exercise experience attribute associated with the piece of target exercise content. In operation 855, the processor 710 may determine a torque profile of the piece of target exercise content based on the second user input. In operation 860, the processor 710 may generate a control signal for driving the exercise assistance device 100 according to the determined torque profile. In operation 865, the processor 710 may transmit a control signal to the exercise assistance device 100 through the communication module 730. Operation 845, operation 850, operation 855, operation 860, and operation 865 may correspond to operation 815, operation 820, operation 825, operation 830, and operation 835, respectively, and any duplicate descriptions are omitted.

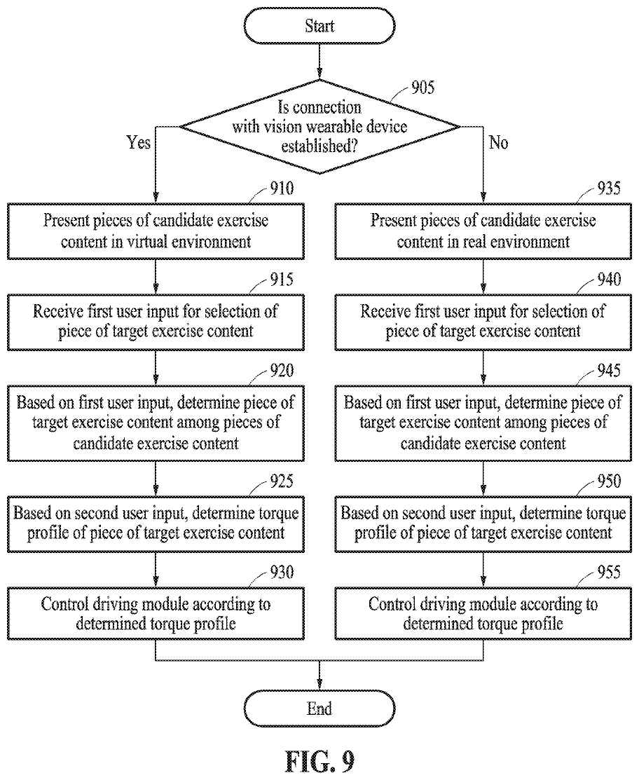

FIG. 9 is a flowchart illustrating operations of a control method performed by an exercise assistance device, according to an embodiment. In an embodiment, at least one of the operations of FIG. 9 may be simultaneously or parallelly performed with one another, and the order of the operations may be changed. In addition, at least one of the operations may be omitted, or another operation may be additionally performed.

Referring to FIG. 9, the processor 512 of the exercise assistance device 100 may present the user with pieces of candidate exercise content using the exercise assistance device 100. Based on whether a connection with a vision wearable device (e.g., the vision wearable device 226 of FIG. 2) is established, the processor 512 may determine pieces of candidate exercise content. First, in operation 905, the processor 512 may determine whether the connection with the vision wearable device is established. In response to the exercise assistance device 100 being connected to the vision wearable device (if “Yes” in operation 905), the processor 512 may present pieces of candidate exercise content in a virtual environment in operation 910. The pieces of candidate exercise content in the virtual environment may include, for example, pieces of assistance-mode-centered exercise content performed in an indoor space. The processor 512 may control to provide a user with a list of pieces of candidate exercise content including at least one of a piece of AR content and a piece of VR content. The list of pieces of candidate exercise content may be provided in the form of a guide voice that provides guidance on what pieces of candidate exercise content are executable in the current state, for example, through the sound output module 550 of the exercise assistance device 100, wireless earphones (e.g., the wireless earphones 222 of FIG. 2), or a vision wearable device.

In operation 915, the input module 540 of the exercise assistance device 100 may receive a first user input including a selection of a piece of target exercise content among the pieces of candidate exercise content. The first user input may be, for example, a voice input of the user, a key/button input on the exercise assistance device 100, or a touch input.

In operation 920, the processor 512 may determine the piece of target exercise content to be executed based on the first user input. Based on the first user input, one of the pieces of candidate exercise content may be determined as the piece of target exercise content. The processor 512 may control to present a list of candidate exercise experience attributes associated with the piece of target exercise content in response to a determination of the piece of target exercise content. The list of candidate exercise experience attributes may be provided in the form of a guide voice that provides guidance on what candidate exercise experience attributes are associated with the piece of target exercise content, for example, through the sound output module 550, the wireless earphones, or the vision wearable device.

The input module 540 may receive a second user input including a selection of an exercise experience attribute associated with the piece of target exercise content. The second user input may be, for example, a voice input of the user, a key/button input on the exercise assistance device 100, or a touch input. When the piece of target exercise content is a piece of exercise content using a single leg, the second user input may include a selection of at least one of exercise experience attributes respectively corresponding to a hip joint angle, a hip joint angular velocity, and a hip joint angular acceleration of the user. When the piece of target exercise content is a piece of exercise content using both legs, the second user input may include a selection of at least one of exercise experience attributes respectively corresponding to an angular difference between angles of both hip joints, an angular velocity difference between angular velocities of both hip joints, and an angular acceleration difference between angular accelerations of both hip joints of the user.

In operation 925, the processor 512, comprising processing circuitry, may determine a torque profile of the piece of target exercise content based on the second user input. According to the selected exercise experience attribute, based on at least one of the hip joint angle, hip joint angular velocity, hip joint angular acceleration of the user wearing the exercise assistance device 100, angular difference between the angles of both hip joints, the angular velocity difference between the angular velocities of both hip joints, and the angular acceleration difference between the angular accelerations of both hip joints of the user, the processor 512 may determine a torque profile.

In operation 930, the processor 512 may control a driving module (e.g., the driving module 530 and/or the driving module 530-1) of the exercise assistance device 100 according to the determined torque profile. The processor 512 may determine an input variable to be applied to the torque profile based on sensor data (e.g., a hip joint angle) obtained through the sensor module 520 of the exercise assistance device 100. The input variable may be any one of a hip joint angle, a hip joint angular velocity, a hip joint angular acceleration, an angular difference between angles of both hip joints, an angular velocity difference between angular velocities of both hip joints, and angular acceleration difference between angular accelerations of both hip joints of the user, according to the torque profile. Output torque of a motor included in the driving module may be determined by applying the corresponding input variable to the torque profile.

Based on a determination result of operation 905, when the exercise assistance device 100 is not connected to the vision wearable device (if “No” in operation 905), the processor 512 (which may comprise one or more processors, as discussed herein) may present the pieces of candidate exercise content in the real environment in operation 935. The pieces of candidate exercise content in the real environment may include, for example, pieces of assistance-mode-centered exercise content performed in a real environment (e.g., indoors, at the beach, and on a sandy beach). A case in which the exercise assistance device 100 is not connected to the vision wearable device may include a case in which the user chooses not to use the vision wearable device. The processor 512 may control to provide the user with the list of pieces of candidate exercise content that operate in the assistance mode to assist the body motion of the user. In operation 940, the input module 540 may receive the first user input including a selection of any one of the pieces of candidate exercise content. In operation 945, the processor 512 may determine the piece of target exercise content to be executed based on the first user input. The processor 512 may control to present the list of candidate exercise experience attributes associated with the piece of target exercise content in response to a determination of the piece of target exercise content. The input module 540 may receive a second user input including a selection of an exercise experience attribute associated with the piece of target exercise content. In operation 950, the processor 512 may determine a torque profile of the piece of target exercise content based on the second user input. In operation 955, the processor 512 may control a driving module (e.g., the driving module 530 and/or the driving module 530-1) of the exercise assistance device 100 according to the determined torque profile.

The processor 512 may determine an input variable to be applied to the torque profile based on sensor data (e.g., a hip joint angle) obtained through the sensor module 520 of the exercise assistance device 100 and determine the output torque of the motor included in the driving module by applying the determined input variable to the torque profile. Operation 940, operation 945, operation 950, and operation 955 may correspond to operation 915, operation 920, operation 925, and operation 930, respectively, and any duplicate descriptions are omitted.

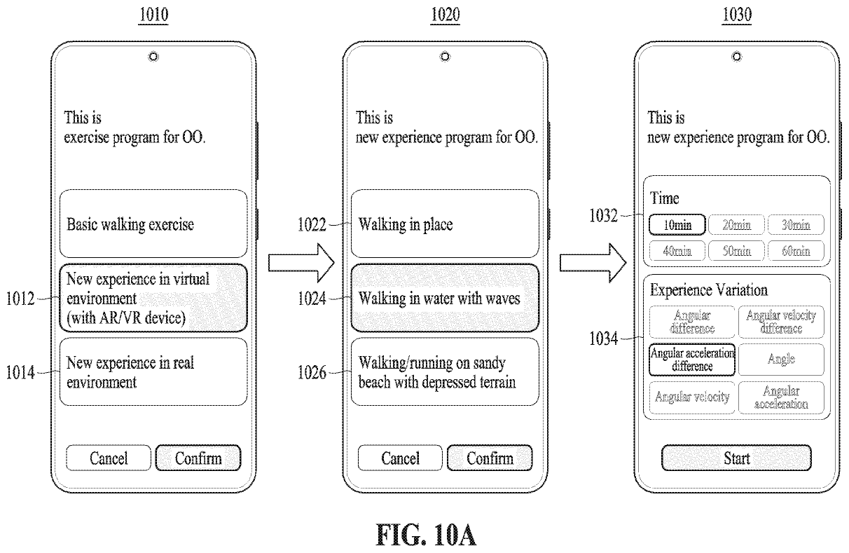

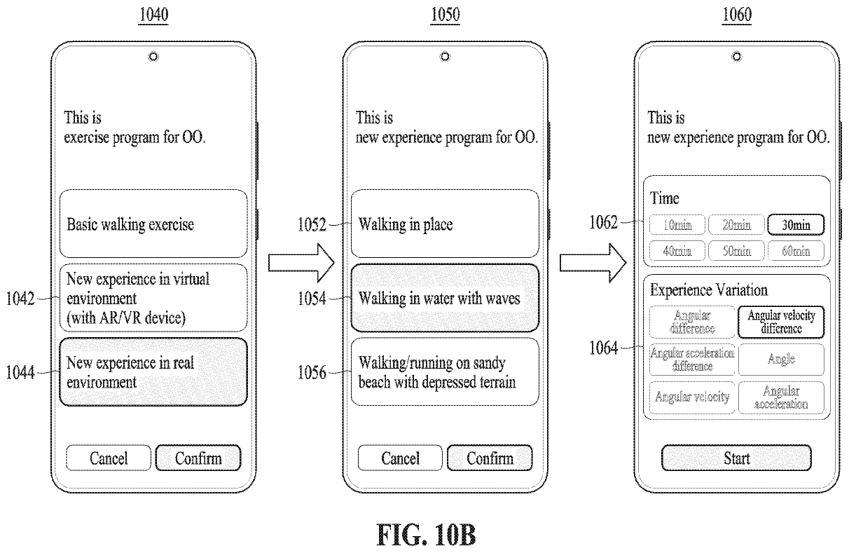

FIGS. 10A and 10B are diagrams illustrating screens of UIs that provide a list of pieces of candidate exercise content and a list of exercise experience attributes, according to an embodiment. The processor 710 of the electronic device 210 may control the display module 740 to output a list of pieces of executable candidate exercise content and/or a list of selectable exercise experience attributes for a piece of target exercise content through a UI.

Referring to FIG. 10A, when the electronic device 210 is connected to, directly or indirectly, a vision wearable device (e.g., the vision wearable device 226 of FIG. 2), the processor 710 may control the display module 740 to output a UI screen 1010 showing that a piece of exercise content 1012 in a virtual environment and a piece of exercise content 1014 in a real environment are selectable. In an embodiment, when the input module 760 of the electronic device 210 receives a user input for selecting the piece of exercise content 1012 in the virtual environment, the processor 710 may control the display module 740 to output a UI screen 1020 including a list of pieces of selectable candidate exercise content 1024 and 1026. The pieces of candidate exercise content may include at least one of a piece of candidate exercise content that operates in a resistance mode that provides resistance to the body motion of a user and/or a piece of AR content and a piece of VR content. For the pieces of candidate exercise content 1024 and 1026, since exercise is not performed in a situation in which the user is actually exercising in water with waves or on a sandy beach with depressed terrain, the pieces of candidate exercise content 1024 and 1026 may operate in the resistance mode that provides resistance to the body motion of the user when the user is exercising, in order to provide a realistic experience.

The input module 760 may receive a user input including a selection of a piece of predetermined candidate exercise content (corresponding to a piece of target exercise content) from a list of pieces of candidate exercise content 1022, 1024, and 1026 displayed on the UI screen 1020. For example, assuming that the piece of candidate exercise content 1024 of “walking in rough waves” is selected as the piece of target exercise content by a user input, the processor 710 may control the display module 740 to output a UI screen 1030 including setting items for the piece of target exercise content. The setting items for the piece of target exercise content may include, for example, an execution time list 1032 of the piece of target exercise content and a list of candidate exercise experience attributes 1034. The execution time list 1032 may include different execution times (e.g., 10 minutes, 20 minutes, 30 minutes, 40 minutes, 50 minutes, and 60 minutes), and the user may select any one of the execution times through a user input. The list of candidate exercise experience attributes 1034 may include selectable candidate exercise experience attributes for the piece of target exercise content. For example, exercise experience attributes may include the candidate exercise experience attributes respectively corresponding to a hip joint angle, a hip joint angular velocity, a hip joint angular acceleration, an angular difference between angles of both hip joints, an angular velocity difference between angular velocities of both hip joints, and an angular acceleration difference between angular accelerations of both hip joints of the user. According to a selected piece of target exercise content, all or some of these candidate exercise experience attributes may be included in the list 1034. Assuming that the user selects a candidate exercise experience attribute corresponding to the angular acceleration difference between the angular accelerations of both hip joints from the list of candidate exercise experience attributes 1034 through a user input, the processor 710 may control the exercise assistance device 100 to operate based on a torque profile based on the angular acceleration difference between the angular accelerations of both hip joints. When a user input for the “start” of the piece of target exercise content is received, the exercise assistance device 100 may be driven based on a torque profile based on the angular acceleration difference between the angular accelerations of both hip joints of the user for an execution time selected by the user under the control of the electronic device 210. The torque profile may be a torque profile that uses the change in the angular acceleration difference between the angular accelerations of both hip joints of the user over time as an input variable and the change in the output torque of the motor of the exercise assistance device 100 as an output variable. When the piece of target exercise content is executed, a piece of AR content related to the piece of target exercise content or a piece of visual content related to a piece of VR content may be output. For example, even though the current location of the user is not actually an underwater environment with waves, a piece of VR content may be provided through the vision wearable device to visually make the user feel as if he or she is walking in water with rough waves.

Referring to FIG. 10B, when the electronic device 210 is not connected to the vision wearable device (e.g., the vision wearable device 226 of FIG. 2), the processor 710 of the electronic device 210 may control the display module 740 to output a UI screen 1040 showing that a piece of exercise content 1044 in a real environment is selectable. When the electronic device 210 is not connected to the vision wearable device, a piece of exercise content 1042 in the virtual environment may not be displayed on the UI screen 1040 or may be disabled so that the piece of exercise content 1042 may not be selected on the UI screen 1040.

In an embodiment, when the input module 760 of the electronic device 210 receives a user input for selecting the piece of exercise content 1044 in the real environment, the processor 710 may control the display module 740 to output a UI screen 1050 including a list of pieces of selectable candidate exercise content 1052, 1054, and 1056. The pieces of candidate exercise content may include the pieces of candidate exercise content 1054 and 1056 that operate in an assistance mode that assists the body motion of the user. For the pieces of candidate exercise content 1054 and 1056, since that exercise is actually performed in water with waves or on a sandy beach with depressed terrain is considered, the pieces of candidate exercise content 1054 and 1056 may be set to operate in the assistance mode that assists the body motion of the user when the user exercises. By receiving an assistance force from the exercise assistance device 100 through the assistance mode, the user may move more easily and continue exercising for a longer period of time in water with waves or on a sandy beach with depressed terrain.

The input module 760 may receive a user input including a selection of a piece of predetermined candidate exercise content (corresponding to a piece of target exercise content) from a list of pieces of candidate exercise content displayed on the UI screen 1050. For example, assuming that the piece of candidate exercise content 1054 of “walking in rough waves” is selected as the piece of target exercise content by a user input, the processor 710 may control the display module 740 to output a UI screen 1060 including setting items for the piece of target exercise content. The setting items for the piece of target exercise content may include, for example, an execution time list 1062 of the piece of target exercise content and a list of candidate exercise experience attributes 1064. The list of candidate exercise experience attributes 1064 may include selectable candidate exercise experience attributes for the piece of target exercise content. For example, exercise experience attributes may include the candidate exercise experience attributes respectively corresponding to a hip joint angle, a hip joint angular velocity, a hip joint angular acceleration of the user, an angular difference between angles of both hip joints, an angular velocity difference between angular velocities of both hip joints, and an angular acceleration difference between angular accelerations of both hip joints of the user. According to a selected piece of target exercise content, all or some of these candidate exercise experience attributes may be included in the list 1064. Assuming that the user selects a candidate exercise experience attribute corresponding to the angular velocity difference between the angular velocities of both hip joints from the list of candidate exercise experience attributes 1064 through a user input, the processor 710 may control the exercise assistance device 100 to operate based on a torque profile based on the angular velocity difference between the angular velocities of both hip joints. When a user input for the “start” of the piece of target exercise content is received, the exercise assistance device 100 may be driven based on a torque profile based on the angular velocity difference between the angular velocities of both hip joints of the user for an execution time selected by the user under the control of the electronic device 210. The torque profile may be a torque profile that uses the change in the angular velocity difference between the angular velocities of both hip joints of the user over time as an input variable and the change in the output torque of the motor of the exercise assistance device 100 as an output variable.

In an embodiment, it is assumed that the user selects “walking in water with waves” as the piece of target exercise content. When the user selects an exercise experience attribute that corresponds to the angular difference between the angles of both hip joints, a torque profile that generates an assistance force that provides a feeling of assistance that offsets a sense of resistance with relatively small variations in water flow may be used. When the user selects an exercise experience attribute that corresponds to the angular velocity difference between the angular velocities of both hip joints, a torque profile that generates an assistance force that provides a feeling of assistance that offsets a sense of resistance with relatively moderate variations in water flow may be used. When the user selects an exercise experience attribute that corresponds to the angular acceleration difference between the angular accelerations of both hip joints, a torque profile that generates an assistance force that provides a feeling of assistance that offsets a sense of resistance with relatively large variations in water flow may be used.

In an embodiment, it is assumed that the user selects “walking/running on a sandy beach with depressed terrain” as the piece of target exercise content. When the user selects an exercise experience attribute that corresponds to the angular difference between the angles of both hip joints, a torque profile that generates an assistance force that offsets a sense of resistance experienced during walking or running on terrain with a relatively small degree of depression may be used. When the user selects an exercise experience attribute that corresponds to the angular velocity difference between the angular velocities of both hip joints, a torque profile that generates an assistance force that provides a feeling of assistance that offsets a sense of resistance experienced during walking or running on a sandy beach with terrain having a relatively moderate degree of depression may be used.

When the user selects an exercise experience attribute that corresponds to the angular acceleration difference between the angular accelerations of both hip joints, a torque profile that generates an assistance force that offsets the resistance experienced during walking or running on terrain with a relatively large degree of depression may be used.

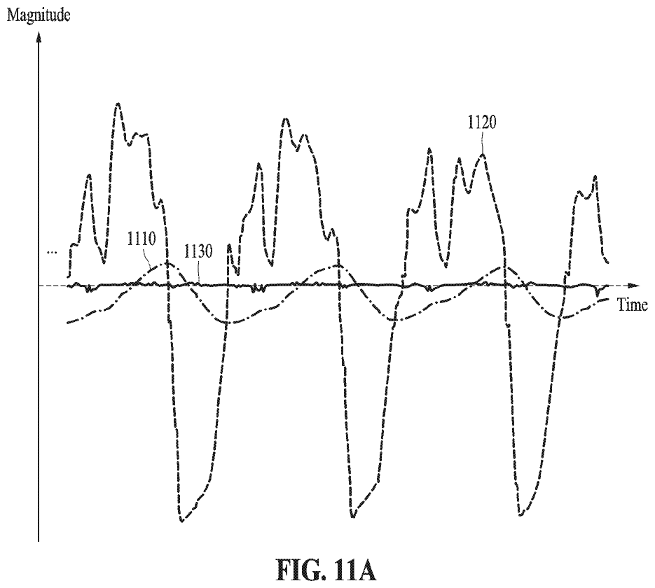

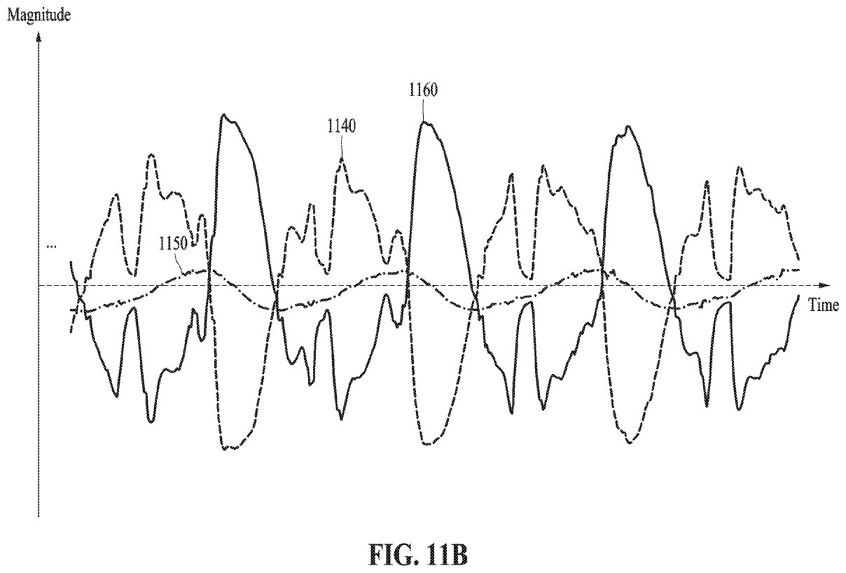

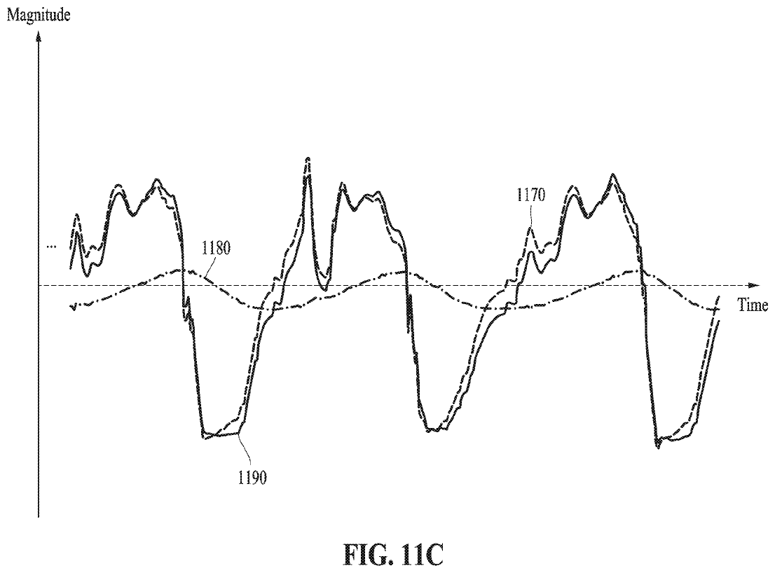

FIGS. 11A, 11B, and 11C are diagrams illustrating signal waveforms related to a hip joint angle, a hip joint angular velocity, and a hip joint angular acceleration of a user, according to an embodiment.

Referring to FIG. 11A, a signal waveform 1110, a signal waveform 1120, and a signal waveform 1130 may represent a hip joint angle (θ), a hip joint angular velocity (ω), and a hip joint angular acceleration (α) of one of the legs of a user over time, respectively. The x-axis may represent time, and the y-axis may represent the magnitude of a signal. Different torque profiles may be used depending on an exercise experience attribute selected by the user. When the selected exercise experience attribute corresponds to the hip joint angle, a torque profile may be determined, for example, as shown in Equation 1.

$$y 1 ( t ) = sin θ ( t - Δ t ) \qquad [ Equation 1 ]$$

Here, y1(t) may represent output torque of a motor of the exercise assistance device 100 at a time t, and θ may represent the hip joint angle of the user. For example, θ may be the hip joint angle of the user measured by an angle sensor of the exercise assistance device 100. sin( ) may represent a sine function, and Δt may represent a time delay value. Δt included in Equations 1 to 10 is a parameter that determines an application time point of the output torque of the motor and may be, for example, a time delay value predefined based on an exercise attribute or a time delay value automatically set (or calculated) based on a selected exercise experience attribute.

When the selected exercise experience attribute corresponds to the hip joint angular velocity, the torque profile may be determined, for example, as shown in Equation 2.

$$y 2 ( t ) = sin ω ( t - Δ t ) \qquad [ Equation 2 ]$$

Here, y2(t) may represent the output torque of the motor of the exercise assistance device 100 at the time t, and ω may represent the hip joint angular velocity of the user. The hip joint angular velocity may be determined by calculating a change in hip joint angle during a unit time. sin( ) may represent a sine function, and Δt may represent a time delay value.

Based on the signal waveform 1110 and the signal waveform 1120, in the time interval between the position at which the hip joint angle reaches a minimum point and the position at which the hip joint angle reaches the next maximum point, the hip joint angular velocity has a positive value, and in the time interval between the position at which the hip joint angle reaches a maximum point and the position at which the hip joint angle reaches the next minimum point, the hip joint angular velocity has a negative value. Considering these characteristics, the direction of torque of the exercise assistance device 100 transmitted to the user may vary depending on whether the device is in an assistance mode that assists the motion of the user or a resistance mode that hinders the motion of the user.

When the selected exercise experience attribute corresponds to the hip joint angular acceleration, the torque profile may be determined, for example, as shown in Equation 3.

$$y 3 ( t ) = sin α ( t - Δ t ) \qquad [ Equation 3 ]$$

Here, y3(t) may represent the output torque of the motor of the exercise assistance device 100 at the time t, and α may represent the hip joint angular acceleration of the user. The hip joint angular acceleration may be determined by differentiating the hip joint angular velocity. sin( ) may represent a sine function, and Δt may represent a time delay value.

Referring to FIG. 11B, a signal waveform 1140, a signal waveform 1150, and a signal waveform 1160 may represent the hip joint angular velocity of one leg of the user over time, the sum of the hip joint angle and the hip joint angular acceleration (e.g., hip joint angle+hip joint angular acceleration), and a value obtained by subtracting the hip joint angular velocity from the hip joint angle (e.g., hip joint angle-hip joint angular velocity), respectively. The signal waveform 1160 may also represent a value obtained by subtracting the hip joint angular velocity from the hip joint angle and then adding the hip joint angular acceleration (e.g., hip joint angle-hip joint angular velocity+hip joint angular acceleration). In an embodiment, the torque profile may be determined based on a value obtained by subtracting the hip joint angular velocity from the hip joint angle to ensure that the direction of the hip joint angle and the direction of the hip joint angular velocity are in the same direction. When the exercise experience attribute selected by the user corresponds to, for example, a value obtained by subtracting the hip joint angular velocity from the hip joint angle, the torque profile may be determined as shown in Equation 4.

$$y 4 ( t ) = sin ( ( θ - ω ) \times ( t - Δ t ) ) \qquad [ Equation 4 ]$$

Here, y4 (t) may represent the output torque of the motor of the exercise assistance device 100 at the time t. θ may represent the hip joint angle of the user, and @ may represent the hip joint angular velocity of the user. sin( ) may represent a sine function, and Δt may represent a time delay value.

Referring to FIG. 11C, a signal waveform 1170, a signal waveform 1180, and a signal waveform 1190 may represent the sum of the hip joint angle and the hip joint angular velocity (e.g., hip joint angle+hip joint angular velocity), the sum of the hip joint angle and the hip joint angular acceleration (e.g., hip joint angle+hip joint angular acceleration), and the sum of the hip joint angle, the hip joint angular velocity, and the hip joint angular acceleration (e.g., hip joint angle+hip joint angular velocity+hip joint angular acceleration) of one leg of the user over time, respectively. In an embodiment, the torque profile may be determined based on the sum of the hip joint angle and the hip joint angular velocity to maintain that the direction of the hip joint angle and the direction of the hip joint angular velocity are opposite to each other. When the exercise experience attribute selected by the user corresponds to, for example, the sum of the hip joint angle and the hip joint angular velocity, the torque profile may be determined as shown in Equation 5.

$$y 5 ( t ) = sin ( ( θ + ω ) \times ( t - Δ t ) ) \qquad [ Equation 5 ]$$

Here, y5 (t) may represent the output torque of the motor of the exercise assistance device 100 at the time t. θ may represent the hip joint angle of the user, and ω may represent the hip joint angular velocity of the user. sin( ) may represent a sine function, and Δt may represent a time delay value.

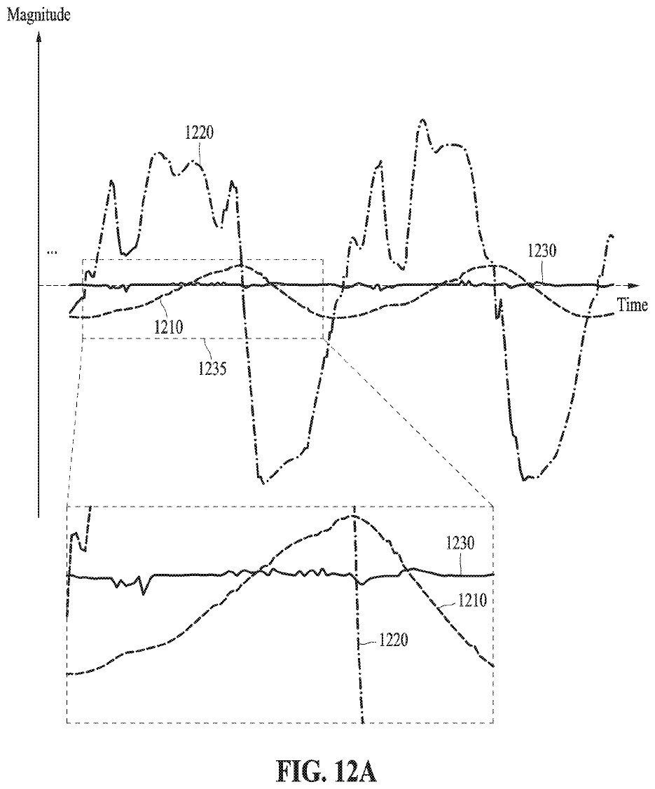

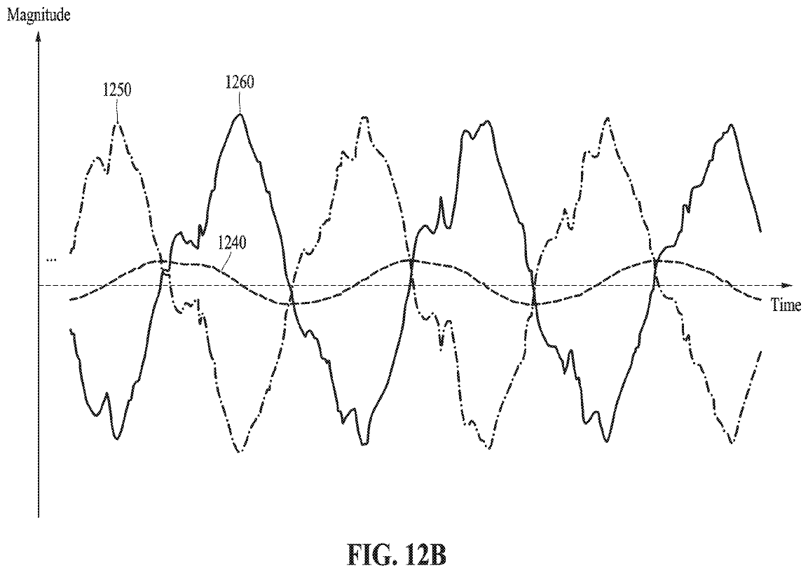

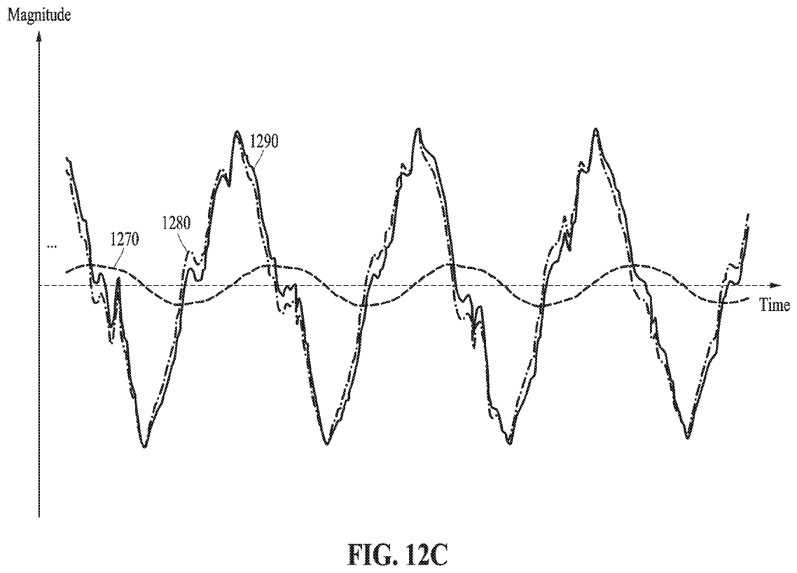

FIGS. 12A, 12B, and 12C are diagrams illustrating signal waveforms related to a hip joint angular difference, a hip joint angular velocity difference, and a hip joint angular acceleration difference of both hip joints of a user, according to an embodiment.

Referring to FIG. 12A, a signal waveform 1210, a signal waveform 1220, and a signal waveform 1230 may represent an angular difference between angles of both hip joints, an angular velocity difference between angular velocities of both hip joints, and an angular acceleration difference between angular accelerations of both hip joints of a user over time, respectively. The x-axis may represent time, and the y-axis may represent the magnitude of a signal. An enlarged view of a region 1235 in the graph is shown at the bottom of the diagram.

Different torque profiles may be used depending on an exercise experience attribute selected by the user. When the selected exercise experience attribute corresponds to the angular difference between the angles of both hip joints, the torque profile may be determined, for example, as shown in Equation 6.

$$y 6 ( t ) = sin ( ( {θ}_{L} - {θ}_{R} ) \times ( t - Δ t ) ) \qquad [ Equation 6 ]$$

Here, y6 (t) may represent output torque of a motor of the exercise assistance device 100 at a time t. θ_{R} may represent an angle of a right hip joint of the user, and θ_{L} may represent an angle of a left hip joint of the user. For example, θ_{R} may be measured by a first angle sensor (e.g., the first angle sensor 524 of FIG. 5B) of the exercise assistance device 100, and θ_{L} may be measured by a second angle sensor (e.g., the second angle sensor 524-1 of FIG. 5B) of the exercise assistance device 100. sin( ) may represent a sine function, and Δt may represent a time delay value.

When the selected exercise experience attribute corresponds to the angular velocity difference between the angular velocities of both hip joints, the torque profile may be determined, for example, as shown in Equation 7.

$$y 7 ( t ) = sin ( ( ω L - ω R ) \times ( t - Δ t ) ) \qquad [ Equation 7 ]$$

Here, y7 (t) may represent output torque of a motor of the exercise assistance device 100 at the time t. ωR may represent an angular velocity of a right hip joint of the user, and ωL may represent an angular velocity of a left hip joint of the user. ωR may be determined by calculating an hourly change in the measured angle of the right hip joint, and ωL may be determined by calculating an hourly change in the measured angle of the left hip joint. sin( ) may represent a sine function, and Δt may represent a time delay value.

Based on the signal waveform 1210 and the signal waveform 1220, in the time interval between the position at which the hip joint angular difference reaches a minimum point and the position at which the hip joint angular difference reaches the next maximum point, the hip joint angular velocity difference has a positive value, and in the time interval between the position at which the hip joint angular difference reaches a maximum point and the position at which the hip joint angular difference reaches the next minimum point, the hip joint angular velocity difference has a negative value. Considering these characteristics, the direction of torque of the exercise assistance device 100 transmitted to the user may vary depending on whether the device is in an assistance mode that assists the motion of the user or a resistance mode that hinders the motion of the user.

When the selected exercise experience attribute corresponds to the angular acceleration difference between the angular accelerations of both hip joints, the torque profile may be determined, for example, as shown in Equation 8.

$$y 8 ( t ) = sin ( ( α L - α R ) \times ( t - Δ t ) ) \qquad [ Equation 8 ]$$

Here, y8 (t) may represent output torque of a motor of the exercise assistance device 100 at the time t. αR may represent an angular acceleration of the right hip joint of the user, and αL may represent an angular acceleration of the left hip joint of the user. αR may be determined by differentiating the angular velocity of the right hip joint, and α1 may be determined by differentiating the angular velocity of the left hip joint. sin( ) may represent a sine function, and Δt may represent a time delay value.

In an embodiment, the angular accelerations of both hip joints may be small during a slow walking section. When a piece of exercise content to be performed is “walking on a sandy beach with depressed terrain,” a torque profile of the exercise assistance device 100 may be determined by reflecting the characteristics of the depressed terrain or the torque profile may be determined based on the angular difference between the angles of both hip joints and the angular acceleration difference between the angular accelerations of both hip joints. For example, the torque profile may be determined as y6 (t)+y8 (t).

The exercise assistance device 100 and the electronic device 210 may provide the user with various exercise experiences by utilizing the characteristics of the hip joint (leg) motion of the user according to a type of a piece of exercise content. As a variation in speed increases or exercise becomes more intense, a fluctuation in a signal waveform of the hip joint angular acceleration of the hip joint angular velocity becomes greater than the hip joint angle. By utilizing these characteristics, it may be possible to provide the user with diverse exercise experiences for the same piece of exercise content through a selection of an exercise experience attribute.

Referring to FIG. 12B, a signal waveform 1240, a signal waveform 1250, and a signal waveform 1260 may represent the angular difference between the angles of both hip joints, the angular velocity difference between the angular velocities of both hip joints, and a value obtained by subtracting the angular velocity difference from the angular difference (e.g., the angular difference between the angles of both hip joints−the angular velocity difference between the angular velocities of both hip joints) of the user over time, respectively. The signal waveform 1260 may also represent a value obtained by subtracting the angular velocity difference from the angular difference and then adding the angular acceleration difference (e.g., the angular difference between the angles of both hip joints−the angular velocity difference between the angular velocities of both hip joints+the angular acceleration difference between the angular accelerations of both hip joints).

In an embodiment, the torque profile may be determined based on a combination of any two or more of the angular difference, the angular velocity difference, and the angular acceleration difference, depending on an exercise experience attribute selected by the user. When the exercise experience attribute selected by the user corresponds to, for example, a value obtained by subtracting the angular velocity difference from the angular difference, the torque profile may be determined as shown in Equation 9.

$$y 9 ( t ) = sin ( ( {θ}_{L} - {θ}_{R} ) - ( ω L - ω R ) ) \times ( t - Δ t ) ) \qquad [ Equation 9 ]$$

Here, y9 (t) may represent output torque of a motor of the exercise assistance device 100 at the time t. θ_{R} may represent an angle of a right hip joint of the user, and θ_{L} may represent an angle of a left hip joint of the user. ωR may represent the angular velocity of the right hip joint of the user, and ωL may represent the angular velocity of the left hip joint of the user. sin( ) may represent a sine function, and Δt may represent a time delay value.

Referring to FIG. 12C, a signal waveform 1270, a signal waveform 1280, and a signal waveform 1290 may represent the angular difference between the angles of both hip joints, the angular velocity difference between the angular velocities of both hip joints, and the sum of the angular difference and the angular velocity difference (e.g., the angular difference between the angles of both hip joints+the angular velocity difference between the angular velocities of both hip joints) of the user over time, respectively. The signal waveform 1290 may also represent a value that is the sum of the angular difference, the angular velocity difference, and the angular acceleration difference (e.g., the angular difference between the angles of both hip joints+the angular velocity difference between the angular velocities of both hip joints+the angular acceleration difference between the angular accelerations of both hip joints).

When the exercise experience attribute selected by the user corresponds to, for example, the sum of the angular difference and the angular velocity difference, the torque profile may be determined as shown in Equation 10.

$$y 10 ( t ) = sin ( ( {θ}_{L} - {θ}_{R} ) + ( ω L - ω R ) ) \times ( t - Δ t ) ) \qquad [ Equation 10 ]$$

Here, y10(t) may represent output torque of a motor of the exercise assistance device 100 at the time t. ω_{R} may represent an angle of a right hip joint of the user, and θ_{L} may represent an angle of a left hip joint of the user. ωR may represent the angular velocity of the right hip joint of the user, and ωL may represent the angular velocity of the left hip joint of the user. sin( ) may represent a sine function, and Δt may represent a time delay value.

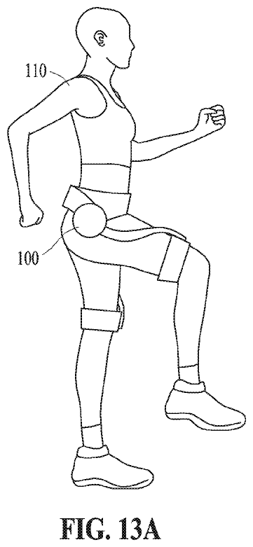

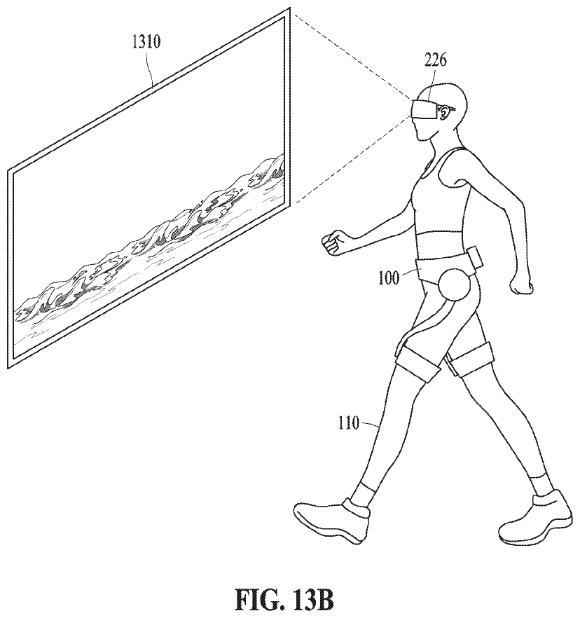

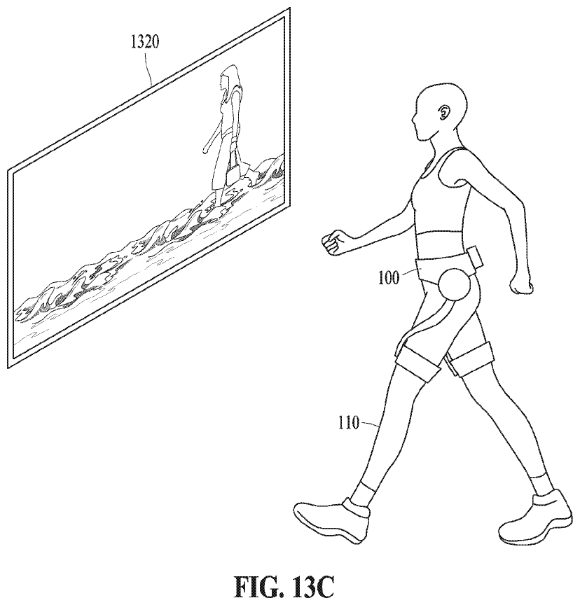

FIGS. 13A, 13B, and 13C are diagrams illustrating examples of providing an exercise experience to a user through an exercise assistance device, according to an embodiment.

Referring to FIG. 13A, the user 110 may exercise using the exercise assistance device 100. For example, the user 110 may wear the exercise assistance device 100 and perform walking exercise or fitness exercise based on a real environment. Depending on a piece of exercise content selected by the user 110, the exercise assistance device 100 may generate torque of an assistance or resistance force. According to an exercise experience attribute selected by the user 110, based on at least one of a hip joint angle, a hip joint angular velocity, a hip joint angular acceleration of the user 110, an angular difference between angles of both hip joints, an angular velocity difference between angular velocities of both hip joints, and an angular acceleration difference between angular accelerations of both hip joints of the user 110, the exercise assistance device 100 may generate torque. The torque generated based on the hip joint angle, the hip joint angular velocity, the hip joint angular acceleration of the user 110, the angular difference between the angles of both hip joints, the angular velocity difference between the angular velocities of both hip joints, and the angular acceleration difference between the angular accelerations of both hip joints of the user 110 may provide different exercise experiences to the user.

Assuming that the user 110 performs a piece of exercise content of “fitness exercise with a single leg,” the exercise assistance device 100 may provide different exercise experiences to the user 110 according to the exercise experience attribute selected by the user 110. When an exercise experience attribute corresponding to the hip joint angle of one leg being exercised is selected, the exercise assistance device 100 may be driven through a torque profile based on the hip joint angle of the corresponding leg. Accordingly, the exercise assistance device 100 may provide the user 110 with a resistance force that creates a natural sense of weight in a resistance mode and may provide the user 110 with an assistance force that creates a natural sense of assistance in an assistance mode. When an exercise experience attribute corresponding to the hip joint angular velocity of one leg being exercised is selected, the exercise assistance device 100 may be driven through a torque profile based on the hip joint angular velocity of the corresponding leg. Accordingly, the exercise assistance device 100 may provide the user 110 with a resistance force that creates a sense of weight including vibration in the resistance mode and may provide the user 110 with an assistance force that creates a sense of assistance including vibration in the assistance mode. When an exercise experience attribute corresponding to the hip joint angular acceleration of one leg being exercised is selected, the exercise assistance device 100 may be driven through a torque profile based on the hip joint angular acceleration of the corresponding leg. Accordingly, the exercise assistance device 100 may provide the user 110 with a resistance force that creates an irregular sense of weight in the resistance mode and provide the user 110 with an assistance force that creates an irregular sense of assistance in the assistance mode.

Referring to FIG. 13B, the user 110 may exercise using the exercise assistance device 100 and the vision wearable device 226. For example, the user 110 may wear the exercise assistance device 100 and perform walking exercise or fitness exercise based on a virtual environment. Through the vision wearable device 226, a piece of AR content or a piece of VR content may be provided. Through the exercise assist device 100, torque may be provided that the user 110 may feel when exercising in the virtual environment provided by the piece of AR content or the piece of VR content. The exercise assistance device 100 and the vision wearable device 226 may provide the user 110 with a realistic exercise experience in the virtual environment. The exercise assistance device 100 and the vision wearable device 226 may provide various virtual exercise experiences, such as walking in water with waves and walking/running on a sandy beach with depressed terrain, even in limited environments such as indoors or on flat ground.

In an embodiment, when the user 110 performs a piece of exercise content of “walking in water with waves,” a piece of visual content 1310 of the user 110 walking in water with waves from a first-person viewpoint may be provided to the user 110 through the vision wearable device 226, and torque of resistance that the user 110 may feel when walking in water with waves may be generated and transmitted to the user 110 through the exercise assistance device 100. The sound of waves generated in the virtual environment may be output through the vision wearable device 226, the exercise assistance device 100, and/or wireless earphones (e.g., the wireless earphones 222 of FIG. 2) worn by the user 110. When waves in the virtual environment hit the body of the user 110, haptic feedback may be generated by a haptic module (e.g., the haptic module 560 of FIGS. 5A and 5B) of the exercise assistance device 100.

The exercise assistance device 100 may provide different exercise experiences to the user 110 according to an exercise experience attribute selected by the user 110. For example, when an exercise experience attribute corresponding to the angular difference between the angles of both hip joints is selected, the exercise assistance device 100 may be driven through a torque profile based on the angular difference between the angles of both hip joints. The exercise assistance device 100 may provide the user 110 with a resistance force that allows the user to feel a sense of resistance with relatively small variations in water flow. When an exercise experience attribute corresponding to the angular velocity difference between the angular velocities of both hip joints is selected, the exercise assistance device 100 may be driven through a torque profile based on the angular velocity difference between the angular velocities of both hip joints. The exercise assistance device 100 may provide the user 110 with a resistance force that allows the user to feel a sense of resistance with relatively moderate variations in water flow. When an exercise experience attribute corresponding to the angular acceleration difference between the angular accelerations of both hip joints is selected, the exercise assistance device 100 may be driven through a torque profile based on the angular acceleration difference between the angular accelerations of both hip joints. The exercise assistance device 100 may provide the user 110 with a resistance force that allows the user to feel a sense of resistance with relatively large variations in water flow.

In an embodiment, when the user 110 performs a piece of exercise content of “walking/running on a sandy beach with depressed terrain,” a piece of visual content of the user 110 walking or running on a sandy beach with depressed terrain from a first-person viewpoint may be provided to the user 110 through the vision wearable device 226, and torque of resistance that the user 110 may feel when walking or running on a sandy beach with depressed terrain may be generated and transmitted to the user 110 through the exercise assistance device 100. The sound generated when walking or running on a virtual sandy beach may be output through the vision wearable device 226, the exercise assistance device 100, and/or wireless earphones (e.g., the wireless earphones 222 of FIG. 2) worn by the user 110.

The exercise assistance device 100 may provide different exercise experiences to the user 110 according to an exercise experience attribute selected by the user 110. For example, when an exercise experience attribute corresponding to the angular difference between the angles of both hip joints is selected, the exercise assistance device 100 may be driven through a torque profile based on the angular difference between the angles of both hip joints. The exercise assistance device 100 may provide the user 110 with a resistance force that creates a sense of walking or running on a sandy beach with terrain having a relatively small degree of depression. When an exercise experience attribute corresponding to the angular velocity difference between the angular velocities of both hip joints is selected, the exercise assistance device 100 may be driven through a torque profile based on the angular velocity difference between the angular velocities of both hip joints. The exercise assistance device 100 may provide the user 110 with a resistance force that creates a sense of walking or running on a sandy beach with terrain having a relatively moderate degree of depression. When an exercise experience attribute corresponding to the angular acceleration difference between the angular accelerations of both hip joints is selected, the exercise assistance device 100 may be driven through a torque profile based on the angular acceleration difference between the angular accelerations of both hip joints. The exercise assistance device 100 may provide the user 110 with a resistance force that creates a sense of walking or running on a sandy beach with terrain having a relatively large degree of depression.

Referring to FIG. 13C, the user 110 may exercise using the exercise assistance device 100 and a display device 1320. The display device 1320 may be a television, a monitor, a projector, a tablet computer, and a laptop. However embodiments are not limited thereto. The user 110 may wear the exercise assistance device 100 and perform walking exercise or fitness exercise based on a real or virtual environment. The motion of the user 110 during exercise may be converted into the motion of the user 110 extracted from a virtual avatar (or character) or image and output to the display device 1320. Here, the image may be obtained by a camera (not shown). Assuming that the user 110 performs a piece of exercise content of “walking in water with waves” as walking exercise based on a virtual environment, a piece of visual content of the user 110 or an avatar corresponding to the user 110 walking in a virtual environment of water with waves may be output through the display device 1320. Motion information of the user 110 measured by a sensor of the exercise assistance device 100 may be transmitted to the display device 1320 or the electronic device 210. The display device 1320 or the electronic device 210 may convert the measured motion information of the user 110 into the motion of the avatar. When the electronic device 210 converts the motion of the user 110 into the motion of the avatar, the electronic device 210 may transmit the motion information of the avatar to the display device 1320. As described in FIG. 13B, the exercise assistance device 100 may provide different exercise experiences to the user 110 depending on an exercise experience attribute selected by the user 110.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., by wire), wirelessly, or via at least third component(s).

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC). Accordingly, each “module” in the present disclosure may include circuitry.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in non-transitory computer-readable storage media. Embodiments as set forth herein may be implemented as software including one or more instructions that are stored in a storage medium that is readable by a machine. For example, a processor of the machine may invoke at least one of the one or more instructions stored in the storage medium and execute it. This allows the machine to be operated to perform at least one function according to the at least one instruction invoked. The one or more instructions may include code generated by a compiler or code executable by an interpreter. A machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although the present disclosure exemplifies and describes with reference to various embodiments, it shall be construed that various embodiments are for the illustrative purpose rather than limiting. It shall be further understood by those skilled in the art that various changes in forms and details may be made without departing from the true spirit and full scope of this disclosure including the scope of the attached claims and their equivalents. In addition, it shall be construed that the embodiment(s) described herein may be used with other embodiment(s) of the present disclosure.

1. An electronic device comprising:
at least one processor comprising processing circuitry; and
a communication module, comprising communication circuitry,
configured to communicate with an exercise assistance device,
wherein the at least one processor is individually and/or collectively configured to:
based on a first user input comprising a selection of at least one piece of candidate exercise content for using the exercise assistance device, determine a piece of target exercise content to be executed;
based on a second user input comprising a selection of an exercise experience attribute associated with the piece of target exercise content, determine a torque profile of the piece of target exercise content;
generate a control signal for driving the exercise assistance device based on the determined torque profile; and
control the communication module to transmit the control signal to the exercise assistance device, and
wherein the torque profile is determined, according to the selected exercise experience attribute, based on at least one of a hip joint angle, a hip joint angular velocity, a hip joint angular acceleration, an angular difference between angles of both hip joints, an angular velocity difference between angular velocities of both hip joints, and an angular acceleration difference between angular accelerations of both hip joints of a user wearing the exercise assistance device.

2. The electronic device of claim 1, wherein the at least one processor is individually and/or collectively configured to:
determine whether the electronic device is connected to a vision wearable device for providing a piece of visual content to the user; and
based on whether a connection with the vision wearable device is established, determine the pieces of candidate exercise content.

3. The electronic device of claim 2, wherein the at least one processor is individually and/or collectively configured to, in response to the electronic device being connected to the vision wearable device, control to provide the user with a list of pieces of candidate exercise content comprising at least one of a piece of augmented reality (AR) content and a piece of virtual reality (VR) content.

4. The electronic device of claim 2, wherein the at least one processor is individually and/or collectively configured to, in response to the electronic device being connected to the vision wearable device, control to provide the user with a list of pieces of candidate exercise content that operate in a resistance mode that provides resistance to a body motion of the user.

5. The electronic device of claim 2, wherein the at least one processor is individually and/or collectively configured to, in response to the electronic device failing to be connected to the vision wearable device, control to provide the user with a list of pieces of candidate exercise content that operate in an assistance mode that assists the body motion of the user.

6. The electronic device of claim 1, wherein when the piece of target exercise content is a piece of exercise content using a single leg, the second user input comprises a selection of at least one of exercise experience attributes respectively corresponding to the hip joint angle, the hip joint angular velocity, and the hip joint angular acceleration of the user.

7. The electronic device of claim 1, wherein when the piece of target exercise content is a piece of exercise content for using both legs, the second user input comprises a selection of at least one of exercise experience attributes respectively corresponding to the angular difference between the angles of both hip joints, the angular velocity difference between the angular velocities of both hip joints, and the angular acceleration difference between the angular accelerations of both hip joints of the user.

8. The electronic device of claim 1, wherein the at least one processor is individually and/or collectively configured to generate the control signal according to one torque profile, among a first torque profile based on the hip joint angle of the user, a second torque profile based on the hip joint angular velocity of the user, a third torque profile based on the hip joint angular acceleration of the user, a fourth torque profile based on the angular difference between the angles of both hip joint, a fifth torque profile based on the angular velocity difference between the angular velocities of both hip joints of the user, and a sixth torque profile based on the angular acceleration difference between the angular accelerations of both hip joints of the user, that corresponds to the selected exercise experience attribute.

9. The electronic device of claim 1, wherein the at least one processor is individually and/or collectively configured to generate the control signal according to any one of a seventh torque profile based on at least two of the hip joint angle, the hip joint angular velocity, and the hip joint angular acceleration of the user and an eighth torque profile based on at least two of the angular difference between the angles of both hip joints, the angular velocity difference between the angular velocities of both hip joints, and the angular acceleration difference between the angular accelerations of both hip joints of the user.

10. An exercise assistance device comprising:
a driving module, comprising a motor and/or circuitry, configured to generate torque;
a torque transmission frame configured for transmitting the generated torque to a leg of a user;
a thigh fastening member connected to the torque transmission frame and configured to connect the torque transmission frame to the leg of the user;
a sensor module, comprising at least one sensor, configured to obtain sensor data comprising motion information of the user; and
at least one processor comprising processing circuitry,
wherein the at least one processor is individually and/or collectively configured to:
based on a first user input comprising a selection of a piece of target exercise content, determine a piece of target exercise content to be executed from pieces of candidate exercise content using the exercise assistance device;
based on a second user input comprising a selection of an exercise experience attribute associated with the piece of target exercise content, determine a torque profile of the piece of target exercise content; and
based on the sensor data and the determined torque profile, control output torque of the motor, and
wherein the torque profile is determined, according to the selected exercise experience attribute, based on at least one of a hip joint angle, a hip joint angular velocity, a hip joint angular acceleration of a user wearing the exercise assistance device, an angular difference between angles of both hip joints, an angular velocity difference between angular velocities of both hip joints, and an angular acceleration difference between angular accelerations of both hip joints of the user.

11. The exercise assistance device of claim 10, wherein the at least one processor is individually and/or collectively configured to:
control to provide a list of pieces of candidate exercise content comprising at least one of a piece of augmented reality (AR) content and a piece of virtual reality (VR) content to the user in response to the exercise assistance device being connected to a vision wearable device for providing a piece of visual content to the user.

12. The exercise assistance device of claim 10, wherein when the piece of target exercise content comprises a piece of exercise content using a single leg, the second user input comprises a selection of at least one of exercise experience attributes respectively corresponding to the hip joint angle, the hip joint angular velocity, and the hip joint angular acceleration of the user.

13. The exercise assistance device of claim 10, wherein when the piece of target exercise content comprises a piece of exercise content using both legs, the second user input comprises a selection of at least one of exercise experience attributes respectively corresponding to the angular difference between the angles of both hip joints, the angular velocity difference between the angular velocities of both hip joints, and the angular acceleration difference between the angular accelerations of both hip joints of the user.

14. The exercise assistance device of claim 10, wherein the at least one processor is individually and/or collectively configured to:
control output torque of the motor based on at least one selected exercise experience attribute among a first torque profile based on the hip joint angle of the user, a second torque profile based on the hip joint angular velocity of the user, a third torque profile based on the angular acceleration of the user, a fourth torque profile based on the angular difference between the angles of both hip joints of the user, a fifth torque profile based on the angular velocity difference between the angular velocities of both hip joints of the user, and a sixth torque profile based on the angular acceleration difference between the angular accelerations of both hip joints of the user.

15. The exercise assistance device of claim 1, wherein the at least one processor is individually and/or collectively configured to:
generate the control signal according to any one of a seventh torque profile based on at least two of the hip joint angle, the hip joint angular velocity, and the hip joint angular acceleration of the user and an eighth torque profile based on at least two of the angular difference between the angles of both hip joints, the angular velocity difference between the angular velocities of both hip joints, and the angular acceleration difference between the angular accelerations of both hip joints of the user.

16. A control method of controlling an exercise assistance device, performed by an electronic device, the control method comprising:
presenting pieces of candidate exercise content using the exercise assistance device;
receiving a first user input comprising a selection of one of the pieces of candidate exercise content;
based on the first user input, determining a piece of target exercise content to be executed;
receiving a second user input comprising a selection of an exercise experience attribute associated with the piece of target exercise content;
based on the second user input, determining a torque profile of the piece of target exercise content; and
generating a control signal for driving the exercise assistance device according to the determined torque profile; and
transmitting the control signal to the exercise assistance device, and wherein the torque profile is determine, according to the selected exercise experience attribute, based on at least one of a hip joint angle, a hip joint angular velocity, a hip joint angular acceleration of a user wearing the exercise assistance device, an angular difference between angles of both hip joints, an angular velocity difference between angular velocities of both hip joints, and an angular acceleration difference between angular accelerations of both hip joints of the user, determining the torque profile.

17. The control method of claim 16, wherein when the piece of target exercise content is a piece of exercise content using a single leg, the second user input comprises a selection of at least one of exercise experience attributes respectively corresponding to the hip joint angle, the hip joint angular velocity, and the hip joint angular acceleration of the user.

18. The control method of claim 16, wherein when the piece of target exercise content is a piece of exercise content for using both legs, the second user input comprises a selection of at least one of exercise experience attributes respectively corresponding to the angular difference between the angles of both hip joints, the angular velocity difference between the angular velocities of both hip joints, and the angular acceleration difference between the angular accelerations of both hip joints of the user.

19. The control method of claim 16, wherein the generating of the control signal comprises generating the control signal according to one torque profile, among a first torque profile based on the hip joint angle of the user, a second torque profile based on the hip joint angular velocity of the user, a third torque profile based on the hip joint angular acceleration of the user, a fourth torque profile based on the angular difference between the angles of both hip joint, a fifth torque profile based on the angular velocity difference between the angular velocities of both hip joints of the user, and a sixth torque profile based on the angular acceleration difference between the angular accelerations of both hip joints of the user, that corresponds to the selected exercise experience attribute.

20. The control method of claim 16, wherein the generating of the control signal comprises generating the control signal according to any one of a seventh torque profile based on at least two of the hip joint angle, the hip joint angular velocity, and the hip joint angular acceleration of the user and an eighth torque profile based on at least two of the angular difference between the angles of both hip joints, the angular velocity difference between the angular velocities of both hip joints, and the angular acceleration difference between the angular accelerations of both hip joints of the user.
